(19) United States
(12) Patent Application Publication
(10) Pub. No.: US 2009/0164356 A1
(43) Pub. Date: Jun. 25, 2009

(54) METHOD, SYSTEM AND APPARATUS FOR CALCULATING CHARGEBACK FOR VIRTUALIZED COMPUTING RESOURCES

(76) Inventor: Alexander Bakman, Durham, NH (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/249,822

(22) Filed: Oct. 10, 2008

Related U.S. Application Data
(60) Provisional application No. 60/960,759, filed on Oct. 12, 2007.
(60) Provisional application No. 61/073,139, filed on Jun. 17, 2008.

(51) Int. Cl. G06Q 30/00; G06Q 10/00; G06Q 50/00

(52) U.S. Cl. 705/34; 705/400

(57) ABSTRACT

Method, system and apparatus for calculating chargeback for virtualized computing resources in a virtualized environment allowing efficient use of computing resources, improving costs recovery including fixed and over-usage cost of utilizing computing resources.

### CROSS-REFERENCE TO RELATED APPLICATIONS

This application claims the benefit under 35 U.S.C. §119(e) of U.S. Provisional Patent Application. No. 60/960,759, filed on Oct. 12, 2007, and U.S. Provisional Patent Application. No. 61/073,139, filed on Jun. 17, 2008 in the U.S. Patent and Trademark Office, the entire disclosures of which are hereby incorporated by reference.

### FIELD OF THE INVENTION

The present invention generally relates to a method and system for calculating and presenting chargeback related to virtualized computing resources. More particularly, exemplary implementations of the present invention relate to determining and presenting chargeback relating to consumption and usage of virtualized computing resources.

### BACKGROUND OF THE INVENTION

Generally, virtualization lets one computer do the job of multiple computers, by sharing computing resources across multiple environments (for example, information technology (“IT”), hardware and software environment). Virtualization was first developed to partition large, mainframe hardware. Thereafter, computers based on x86 architecture were faced with similar problems of rigidity and underutilization that mainframes faced in the past. Partitioning allowed mainframes to multi-task by running multiple applications and processes at the same time. Since computing resources were and still are expensive, partitioning allowed a way to fully leverage the investment in computing resources. Recent developments from past mainframe computing to x86 computing has introduced new computing resources infrastructure and operations challenges. These challenges include, but are not limited to:
1. Low infrastructure utilization
2. Increasing physical infrastructure costs
3. Increasing computing resources management costs
4. Insufficient failover and disaster protection
5. High maintenance end-user computing resources

As organizations embrace virtualization, they are consolidating existing computing resources into fewer and more powerful computing resources. The new computing resources are shared resources by users from many departments. Organizations have a need to figure out how to charge multiple departments/cost centers/users/entities for the use of computing resources actually used.

A virtual machine (“VM”) is a type of computer application used to create a virtual environment, which can be referred to as virtualization. Many organizations are rapidly adopting virtualization technology to simplify the use and management of physical computing resources, save energy and perhaps reducing computing resources. Reducing the number of physical servers through virtualization technologies allows for one or more VM to run on one or more physical servers.

Conventionally, standard size VMs are loosely divided into small, medium and large sizes. The size can represent the amount of resources (for example, memory, storage, CPU, and so on) that's been allocated for each virtual machine size. Many organizations may be able to compute the cost for each size of VM based on the size of the virtual machines. This can represent a “fixed” cost model of utilizing resources that can be charged to entities, organizations and/or end users. End users may use more resources than have been allocated to them. This presents a problem for IT departments when entities use computing resources beyond what was allocated to them.

Embodiments of present invention overcome some of these concerns relating to usage of virtualized computing resources.

Embodiments of the invention propose methods, systems and apparatuses for addressing at least the above noted needs.

### SUMMARY OF THE INVENTION

Accordingly, exemplary embodiments of the present invention relate to a method, system and apparatus to accurately calculate, report and recover costs of using virtualized computing resources, from entities (for example, organizations and/or users). Entities can efficiently and accurately utilize virtualized computing resources by metering resource usage and then charging back for the use of extra resources beyond what was allocated, including fixed and over-usage cost of virtualized computing resources. Exemplary embodiments of the present invention provide for a method, system and apparatus for determining and presenting chargeback of usage of virtualized computing resources.

Exemplary implementations of the present invention allow for recovering expenses over a period of time, spreading the cost among multiple cost centers, charging users for the resources they actually use, and quantify resource usage based on specific rates to fully recover expenses relating to virtualized computing resources. Certain implementations of the present invention allow organizations to provide for additions and removals of software, hardware and storage.

Exemplary embodiment of the present invention relate to calculating and/or presenting chargeback amounts and/or costs for one or more chargeback models including (1) Resources Consumed model, (2) Fixed Price model, and 3) Fixed Price plus Over-usage model. Certain implementations of the present invention provide users to customize the chargeback models (for example, fields) and presentations.

Exemplary embodiments of the present invention overcome the limitations of the conventional pricing models. According to implementations of the present invention, a physical server does not limit the utilization of computing resources. Resource pools and clusters can determine where and how resources will be used. Implementations of the present invention relate to dynamically determining resource consumption, regardless of which host resources are utilize and accurately calculating and recovering costs for usage of computing resources.

Exemplary embodiments of the present invention provide for a method comprising determining one or more rate associated with determining chargeback for one or more virtual machine, specifying a time period for calculating chargeback for each virtual machine, specifying at least one cost center associated with each virtual machine, determining consumption of virtualized computing resources for each virtual machine in the specified time period, calculating chargeback for each cost center based for each virtual machine, and generating a notification comprising said chargeback, wherein each virtual machine is associated with virtualized computing resources.

Exemplary embodiments of the present invention provide for a method for calculating and presenting chargeback of virtualized resources, the method comprising determining virtualized resources related to one or more virtual machine, setting one or more fixed usage threshold parameters for the virtualized resources, setting one or more over-usage parameters for the virtualized resources, determining rates for the usage of virtualized resources for each virtual machine, wherein the rates comprise a unit cost for fixed usage and over-usage of virtual resources, measuring, for each virtual machine, consumption of the virtualized resources, determining that over-usage of the virtualized resources has occurred when usage of at least one of the virtualized resources exceeds the fixed usage threshold parameters, calculating chargeback amounts and chargeback costs comprising calculating fixed usage amounts and cost, and further calculating over-usage amounts and costs when over-usage is determined, based on said rates, generating a notification, comprising information indicative of at least one of chargeback amounts and chargeback costs, and presenting the notification.

Exemplary embodiments of the present invention provide for a method for calculating and presenting chargeback of virtualized resources in a virtualized environment, the method comprising identifying each virtual machine in the virtualized environment, specifying a time period for calculating chargeback costs for each virtual machine, specifying each cost center associated with each virtual machine, determining rates for the virtualized computing resources associated with each virtual machine, determining consumption of virtualized computing resources used by the cost center for each virtual machine within the time period, calculating, for each virtual machine, chargeback costs for each cost center, and generating a notification presenting chargeback costs, wherein the chargeback costs reflect fixed plus over-usage of virtualized computing resources for each cost center and the rate, wherein virtualized computing resources comprise one or more servers, a CPU, memory, storage and network, and wherein calculating chargeback further comprises setting one or more fixed usage threshold parameters for the virtualized resources, setting one or more over-usage parameters for the virtualized resources, determining that over-usage of the virtualized resources has occurred when usage of at least one of the virtualized resources exceeds the fixed usage threshold parameters, calculating chargeback amounts and chargeback costs comprising calculating fixed usage amounts and cost, and further calculating over-usage amounts and costs when over-usage is determined, based on said rates.

Additionally, Embodiments described in the present application relate to a fixed plus overage model for usage of virtualized computing resources and present technique that facilitates ease of budgeting of fixed priced per VM model and the protection from resource over usage offered by measuring the actual resource consumption and recovering the over usage from one or more entities.

It would be understood by one of ordinary skill in the art that a method incorporating any combination of the details mentioned above would fall within the scope of the present invention as determined based upon the exemplary claims below and any equivalents thereof.

Other objects, advantages and salient features of the invention will become apparent to those skilled in the art from the details provided, which, taken in conjunction with the annexed drawings, disclose exemplary embodiments of the invention.

### BRIEF DESCRIPTION OF THE DRAWINGS

The above and other aspects, features and advantages of the certain exemplary embodiments of present invention will be more apparent from the following detailed description when taken in conjunction with the accompanying drawings, in which:

FIGS. 1-3 and 60) are schematic block diagrams illustrating features of the architecture of the virtual computing environment relating to chargeback, according to exemplary embodiments of the present invention.

FIGS. 4-51) illustrate computer generated displays exemplifying features related to chargeback for virtual computing resources, according to exemplary embodiments of the present invention.

FIGS. 52-59) illustrate flowcharts showing the basic operations of chargeback in a virtual computing environment, according to exemplary embodiments of the present invention.

Throughout the drawings, like reference numerals will be understood to refer to like elements, features and structures

### DESCRIPTION OF EXEMPLARY EMBODIMENTS

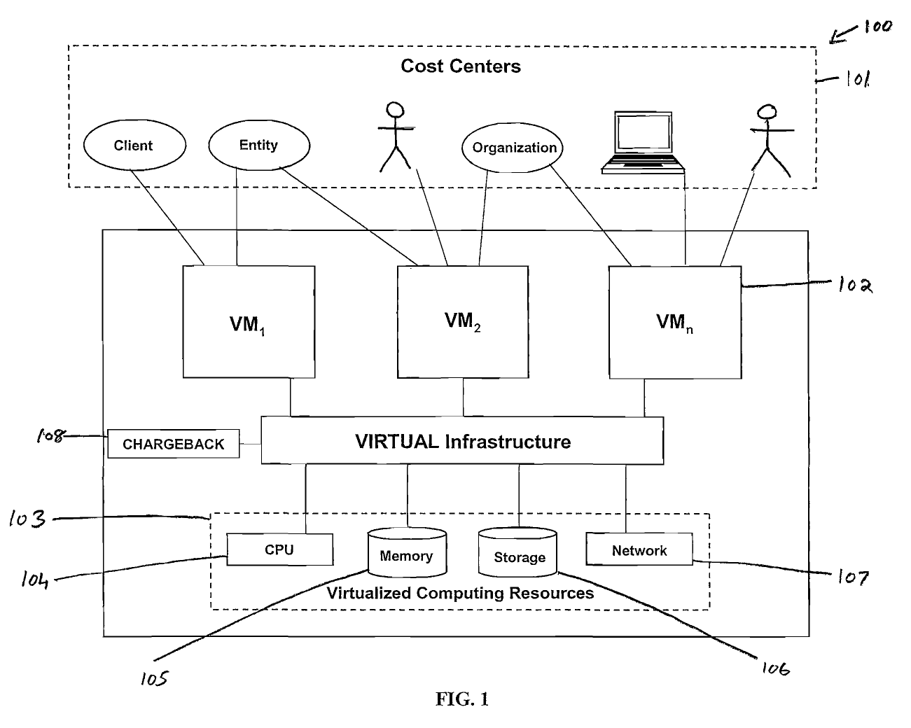

The matters exemplified in this description are provided to assist in a comprehensive understanding of exemplary embodiments of the invention. FIG. 1 shows embodiments of the present invention provide a method, system and apparatus for determining and presenting chargeback 108 of usage of virtualized computing resources 103 in a computing environment 100. Specific embodiments provide a method, system and apparatus for determining and presenting resources consumed, fixed usage and/or over-usage models for representing actual usage of virtualized computing resources 103. Accordingly, those of ordinary skill in the art will recognize that various changes and modifications of the embodiments described herein can be made without departing from the scope and spirit of the claimed invention. Also, descriptions of well-known functions and constructions are omitted for clarity and conciseness.

Exemplary embodiments of the present invention address drawbacks of conventional systems and methods as described in, for example, US Pub No. 2008/0126547 A1 and U.S. Pat. No. 7,412,492 B1, the disclosures of which are hereby incorporated by reference in their entirety.

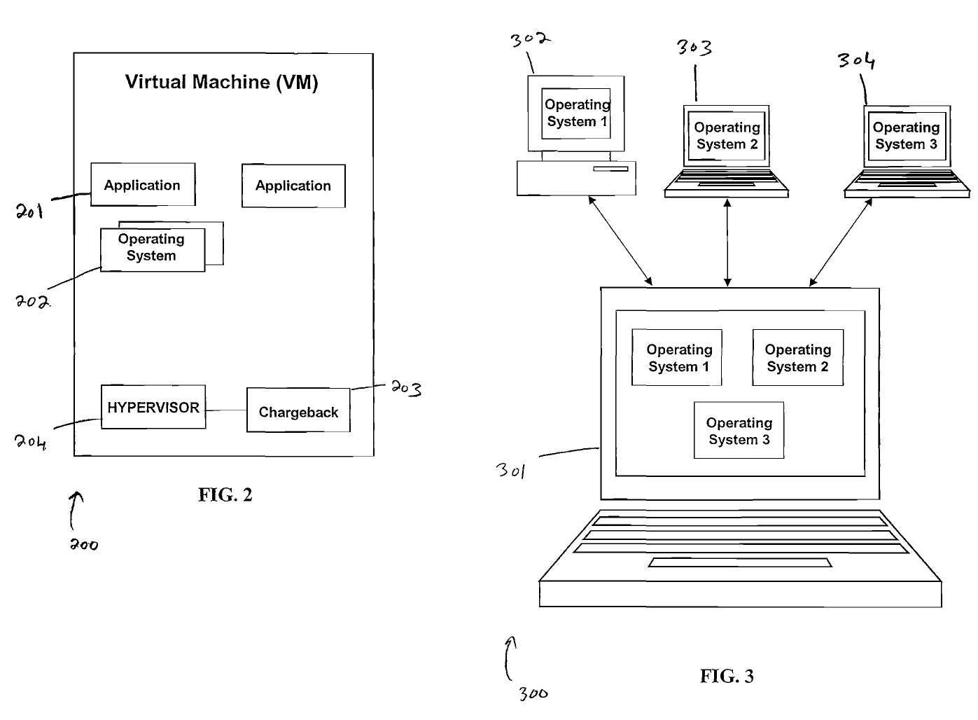

FIGS. 2 and 3 shows that virtualization 300 essentially provides for one computer 301 doing the job of multiple computers 302, 303, 304, by sharing resources of a single computer 301 across multiple computing environments 302, 303, 304. Virtual servers and virtual desktops let entities host multiple operating systems 301 and multiple applications locally and in remote locations, freeing them from physical and geographical limitations. This leads to lower capital expenses due to more efficient use of computing resources, high availability of computing resources, better management of computing resources, increased security and improved disaster recover process.

According to an exemplary embodiment, as shown in FIG. 2, a VM 200 is a tightly isolated software (for example, a folder, a container, and so on) that can run it's own operating system 202 and applications 201 as if it were a physical computer. A VM 200 behaves like a physical computer and can be associated with virtual (for example, software-based) CPU 104, memory (for example, RAM) 105, storage 106 and network 107 (for example, network interface cards (“NIC”)). A VM 200 can be comprised entirely of software with no direct relation to any real hardware. As a result, VMs offer a number of distinct advantages over physical hardware.

In general, VMs provide at least the following benefits:
1. Compatibility—VMs are compatible with all standard x86 computers.
2. Isolation—VMs are isolated from each other as if physically separated.
3. Encapsulation—VMs encapsulate a complete computing environment.
4. Hardware Independence—VMs run independently of underlying hardware.

According to exemplary implementations of virtual computing environments, an operating system cannot tell the difference between a virtual machine and a physical machine, nor can applications or other computers on a network.

According to exemplary embodiments of the present invention, a virtual machine can be a computer application 301 used to create a virtual environment allowing entities to run multiple operating systems 302, 303, 304 at the same time through the use of software located on the computer platform.

VM can be implemented in various exemplary environments/implementations of the present application. VMs can be implemented as hardware virtual machine software, also known as hypervisor 204. Hypervisor allows multiple identical executions on one computer 301. In turn, each of these executions can run on various operating systems. Through the use of the hardware virtual machine software, a user can have a seemingly private machine with fully functional hardware that is separate from the other users. Hardware virtual machine software also allows users to boot and restart their machines quickly since hardware initializations are not necessary.

According to exemplary implementations, VMs can also be implemented as application VM software. Application VM software allows the software application to be isolated from the computer being used. The software is intended to be used on a number of computer platforms. This makes it unnecessary to create separate versions of the same software for different operating systems and computers. Java Virtual Machine is an example of an application VM.

According to other exemplary implementations, VM can also be a virtual environment that is used for running programs at the user level for executing applications and not for drivers or operating system kernels.

According to other exemplary implementations, a VM can also be a group of computers that work together to create a more powerful machine. These implementations of VMs make it possible for one environment 100 to be formed throughout several cost centers (for example, computers, users and/or entities) 101. This makes it appear to the end user as if he or she is using a single computer 301, when they are actually using numerous computers 302, 303, 304.

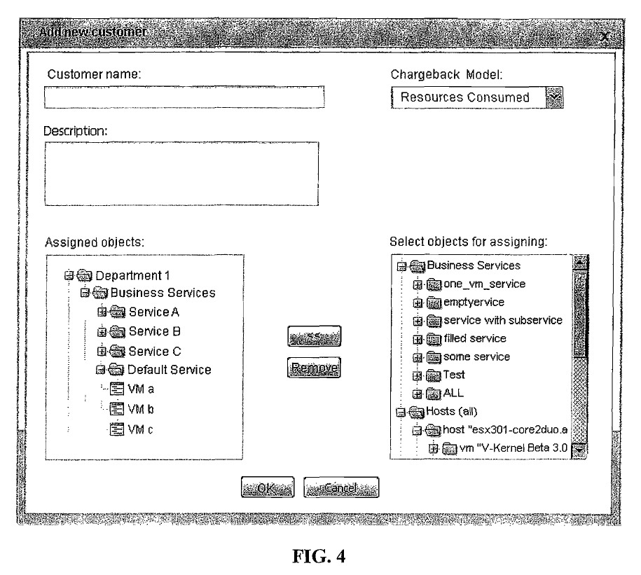

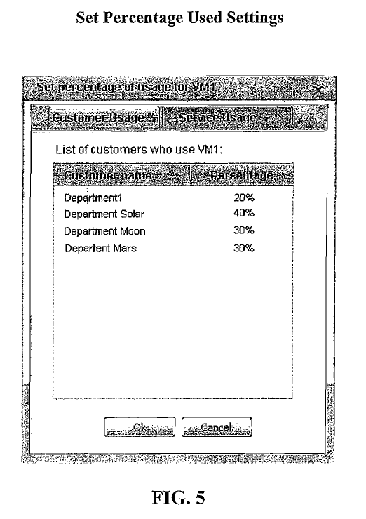

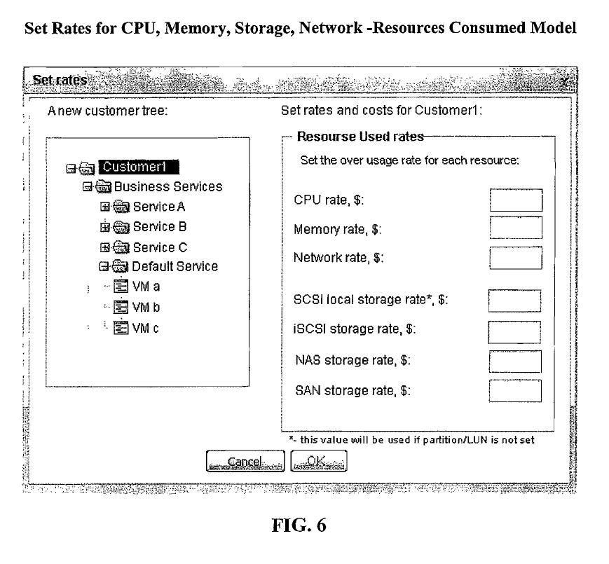

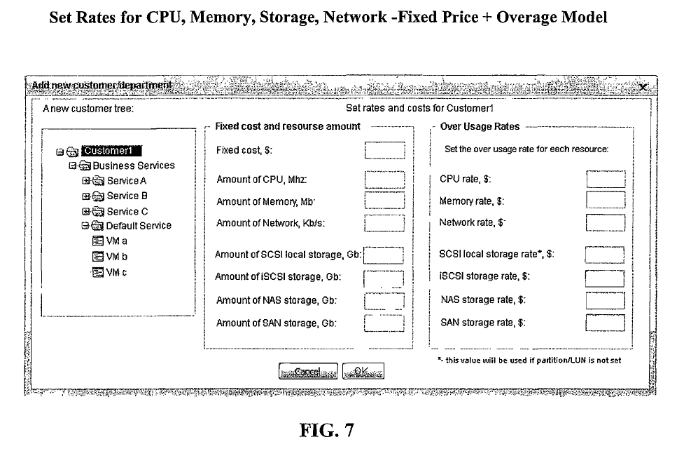

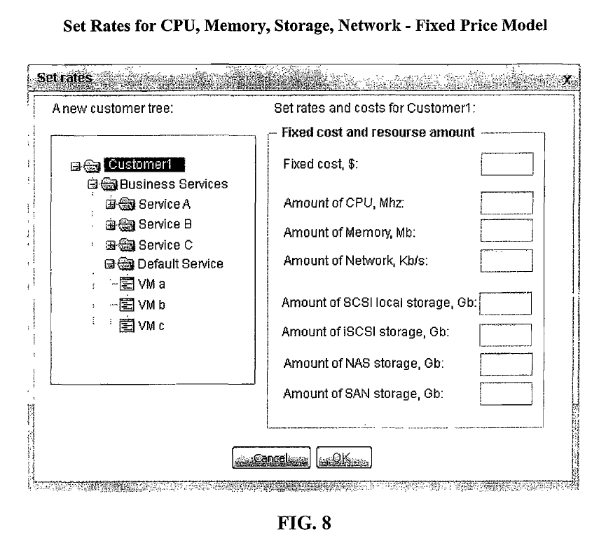

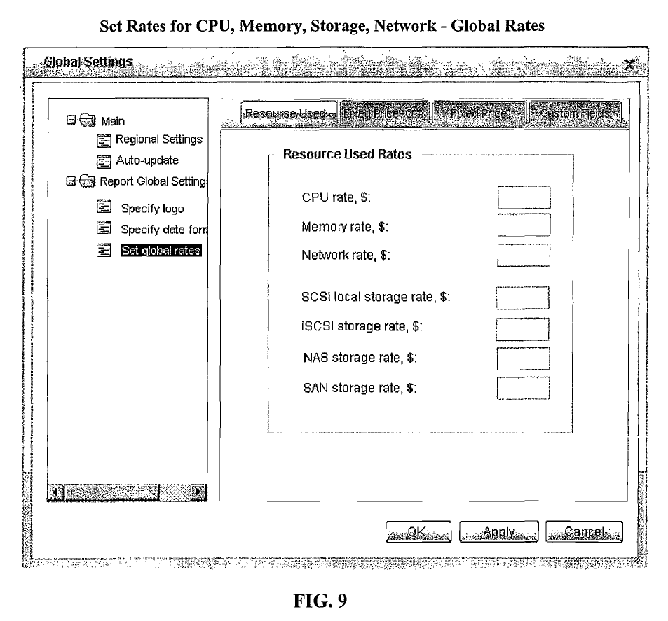

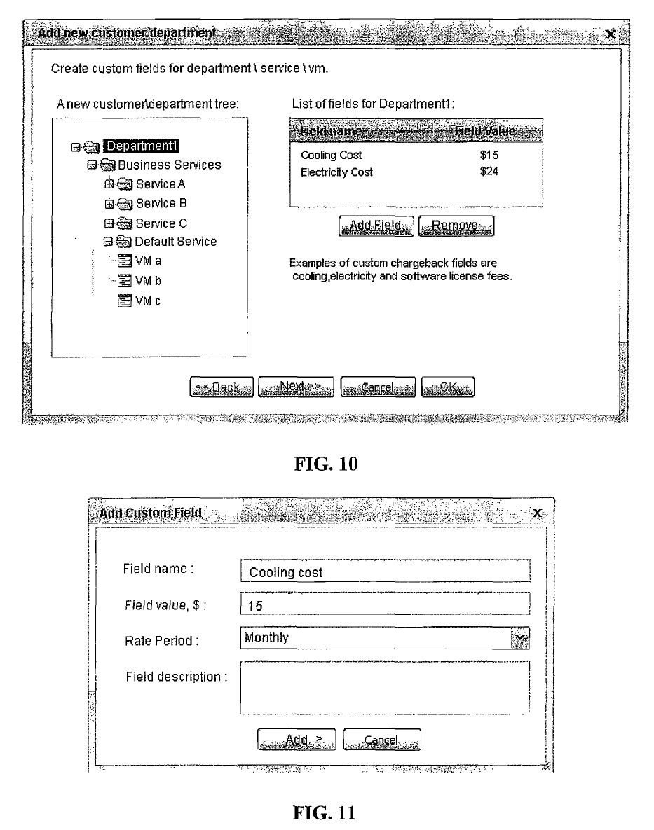

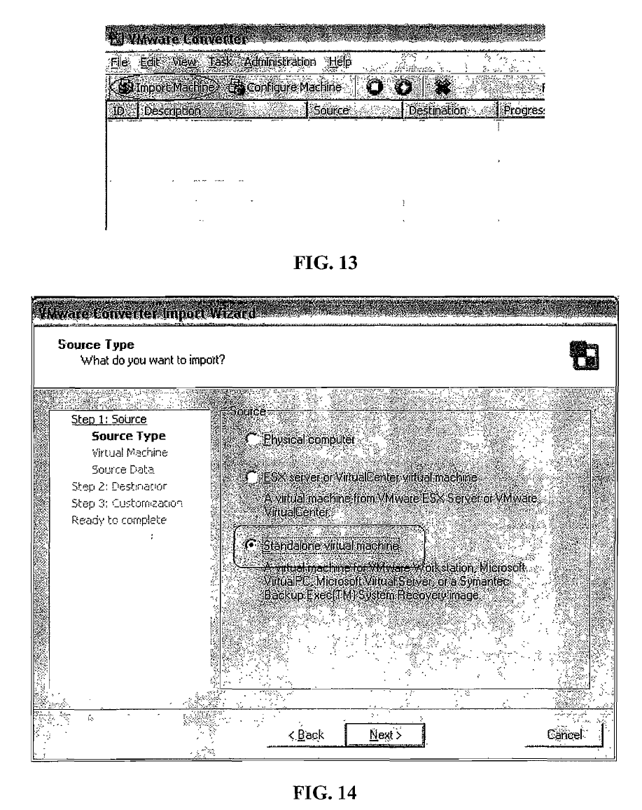

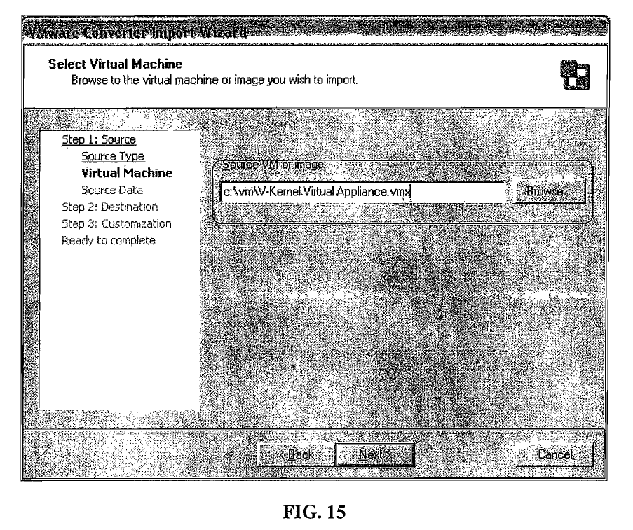

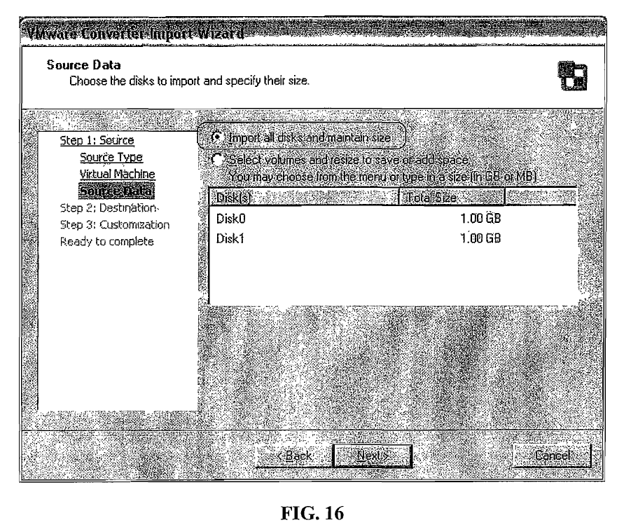

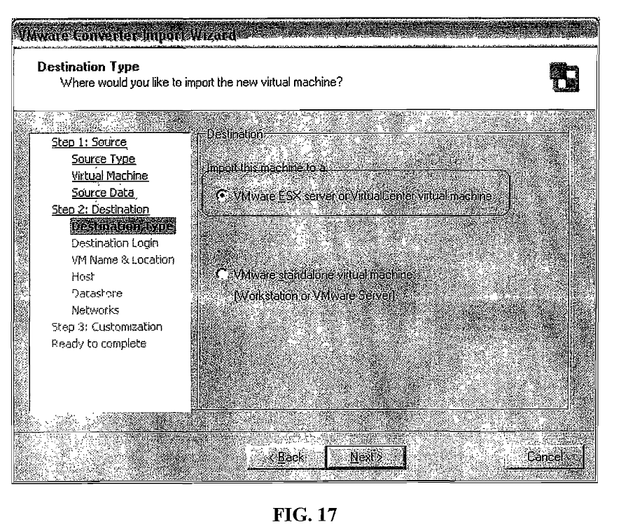

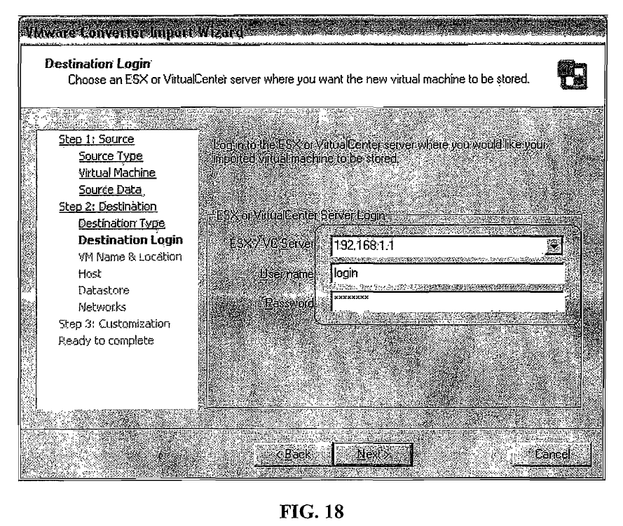

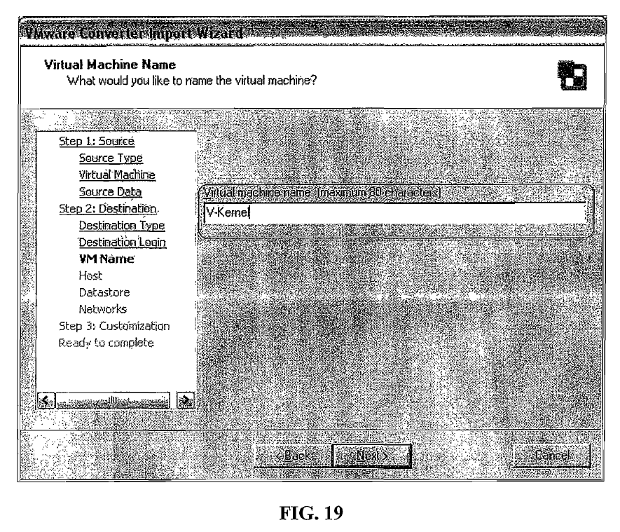

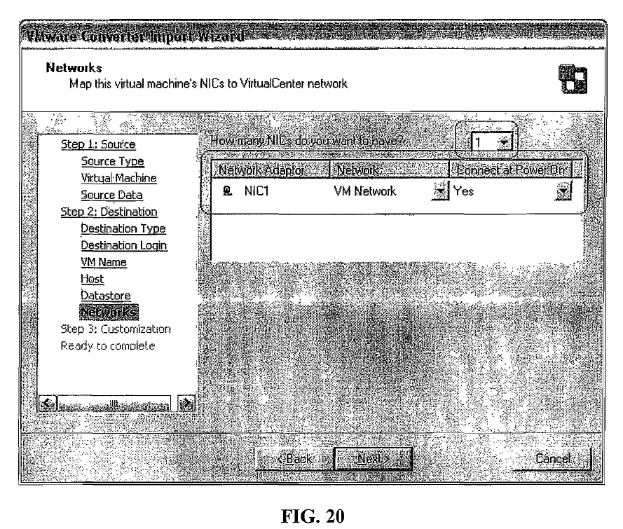

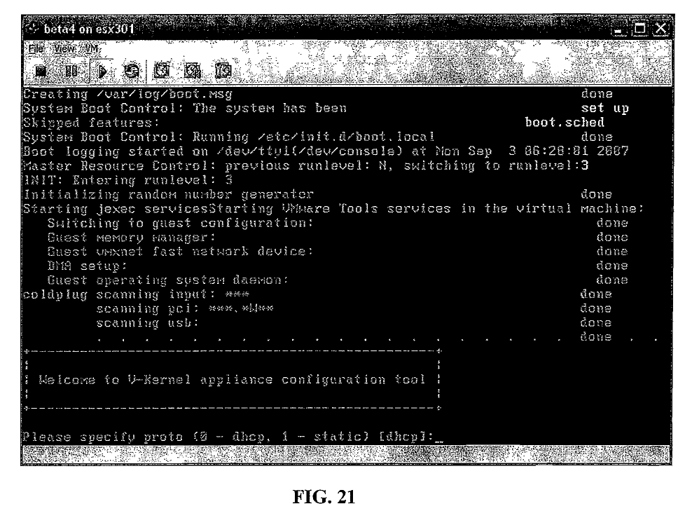

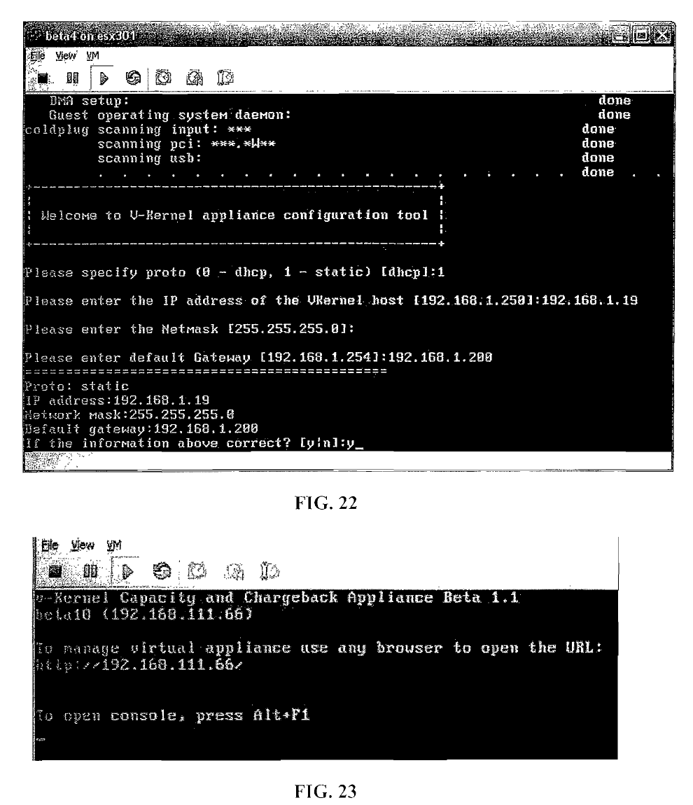

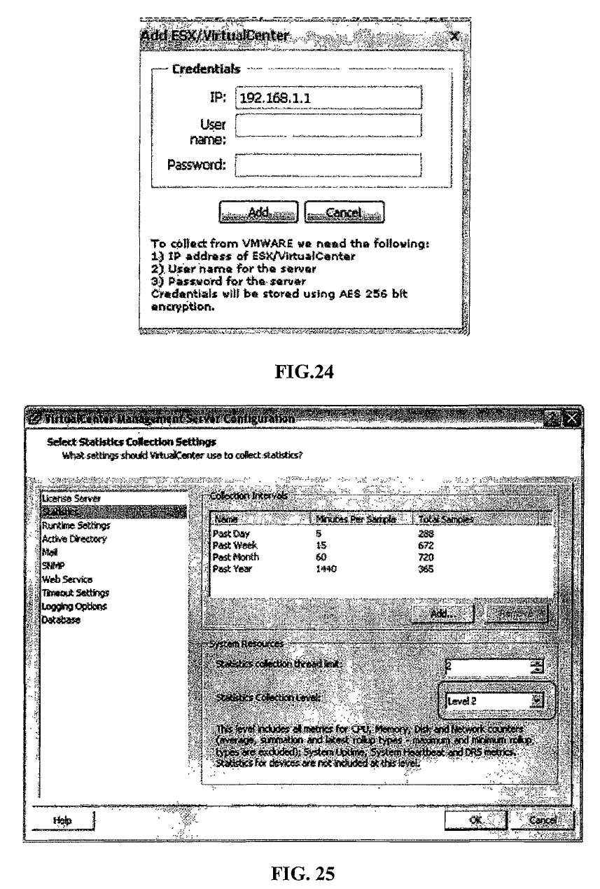

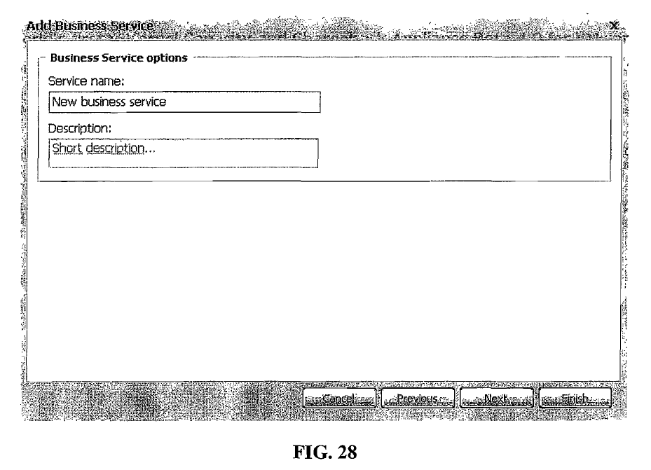

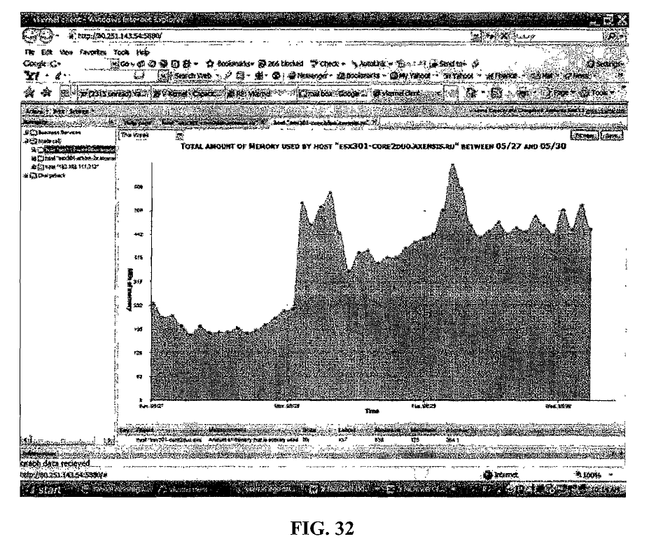

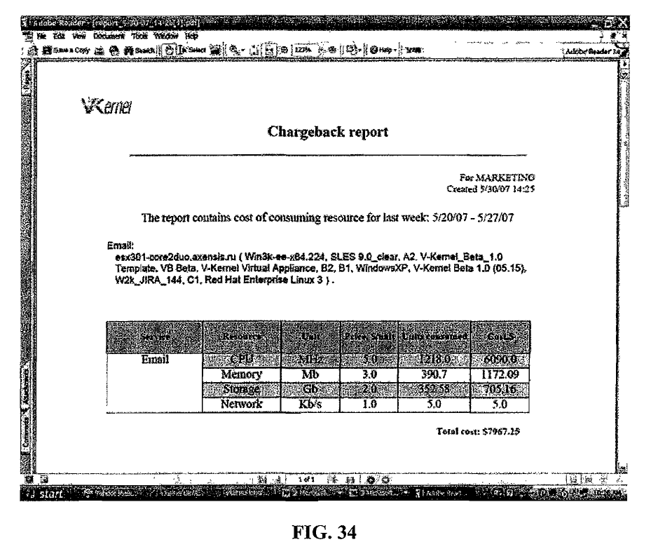

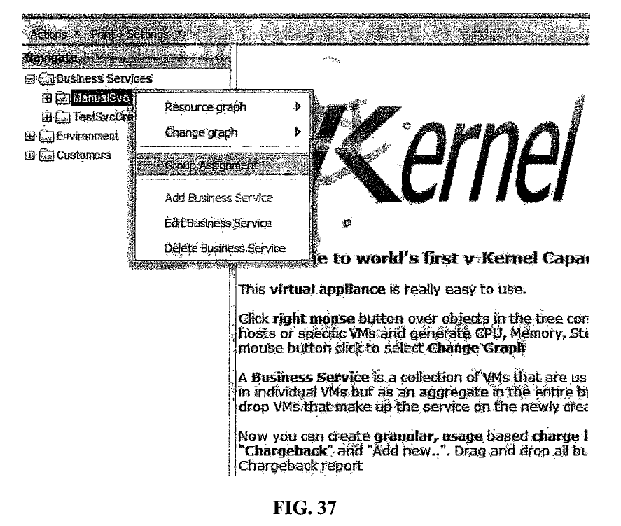

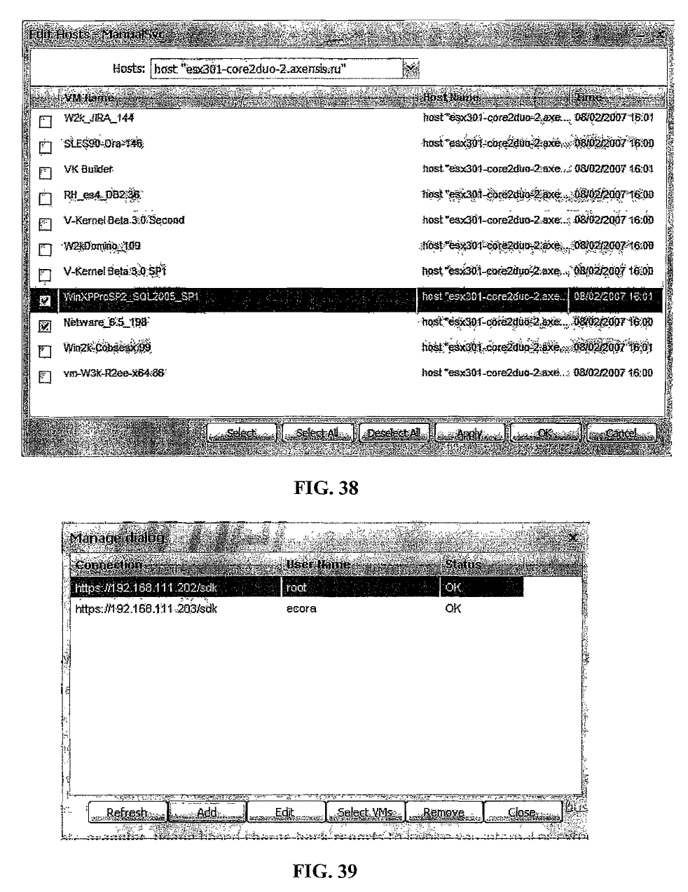

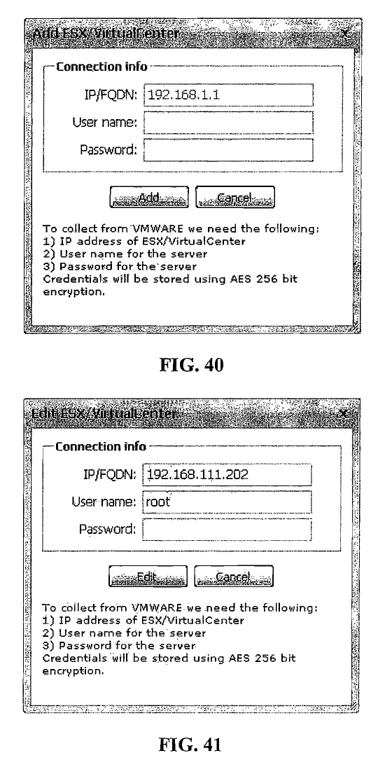

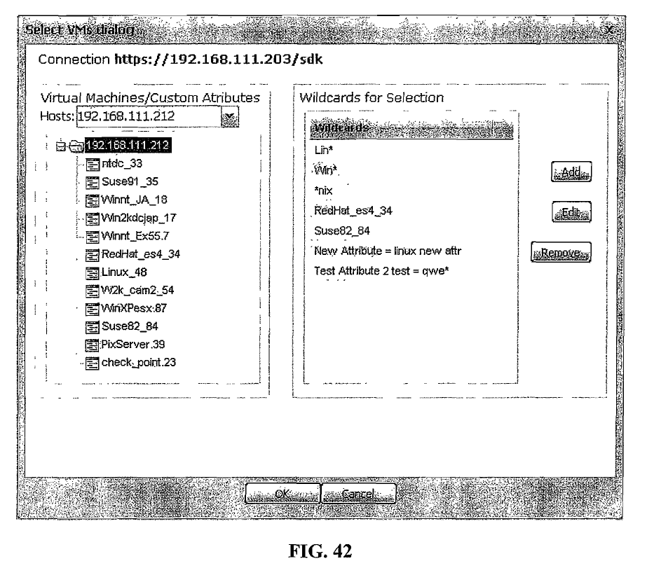

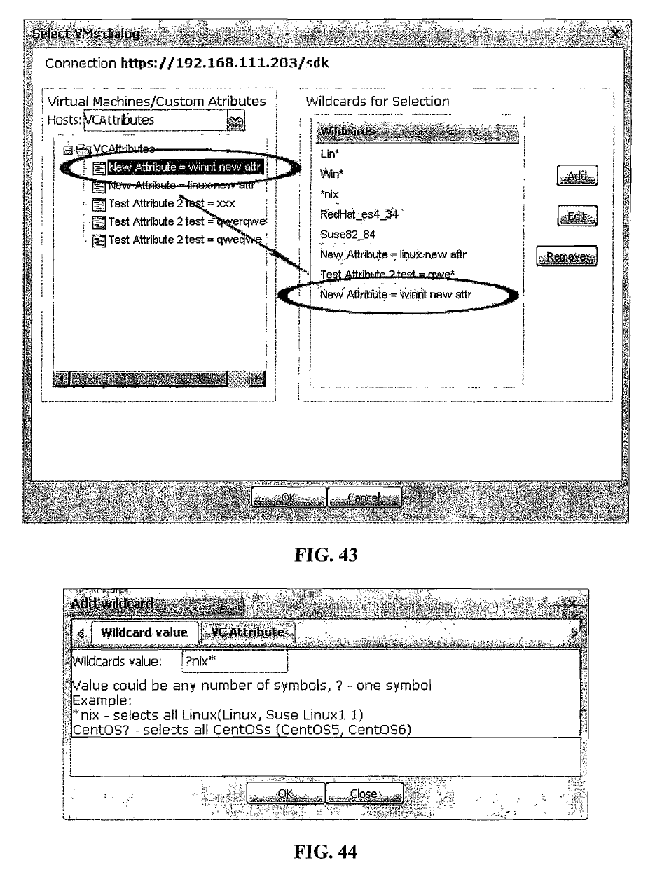

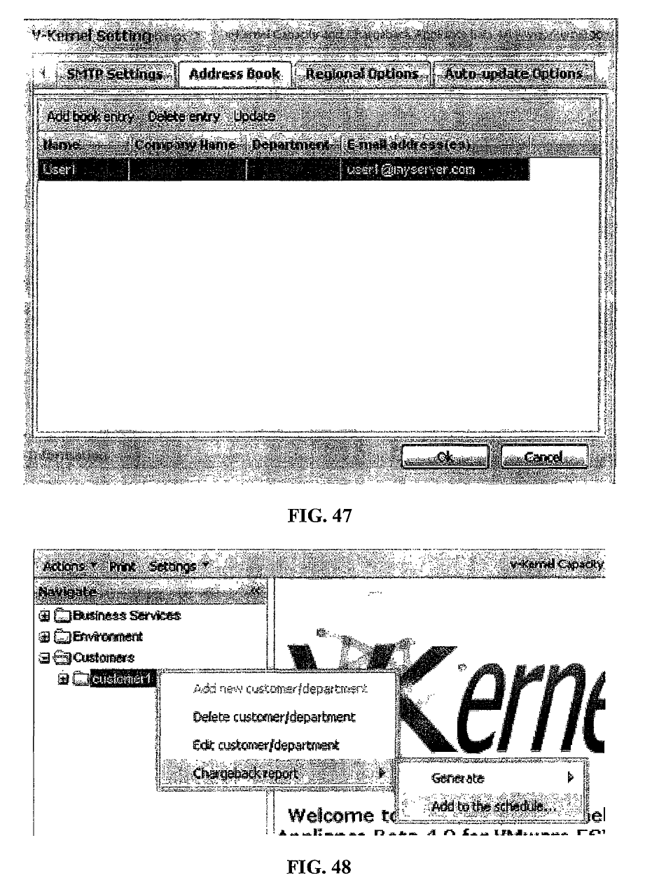

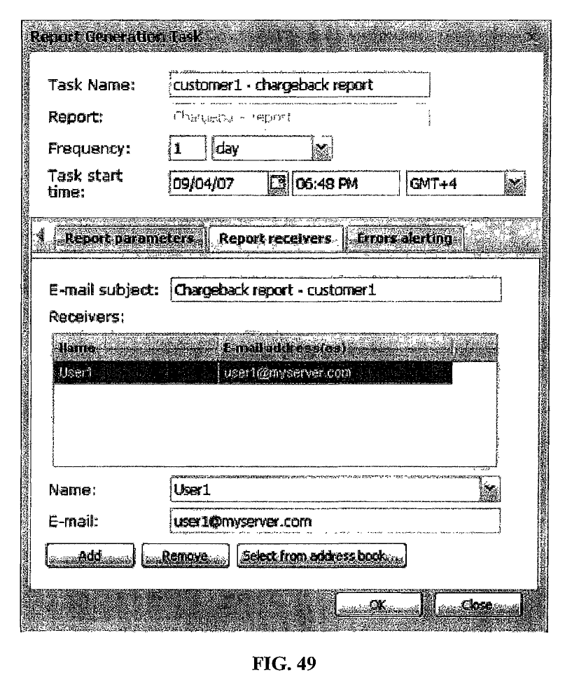

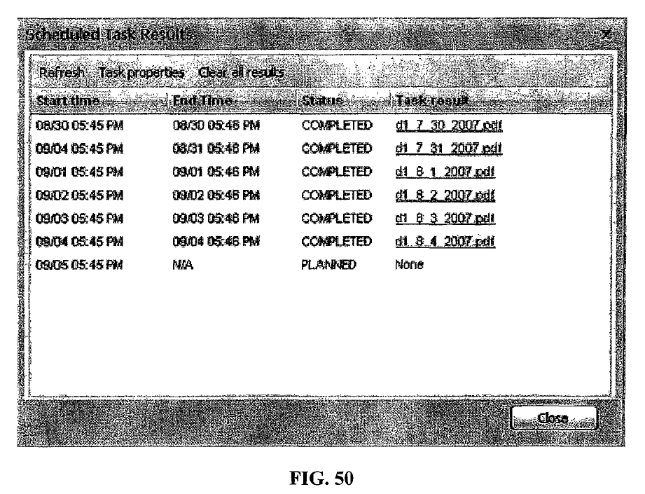

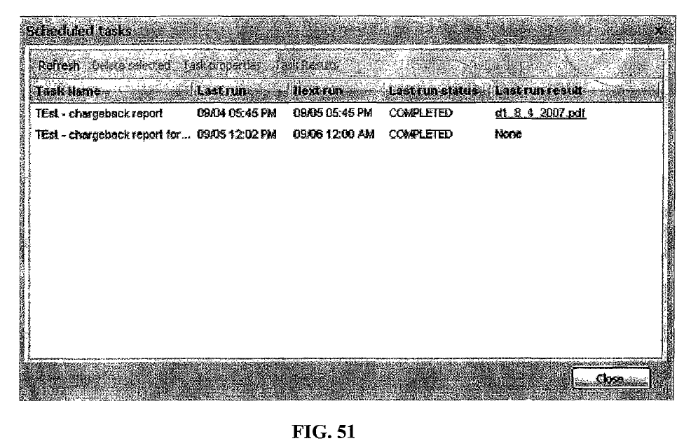

FIGS. 4-51 illustrate computer generated displays exemplifying features related to chargeback for virtual computing resources, according to exemplary embodiments of the present invention, and will be further explained thereafter.

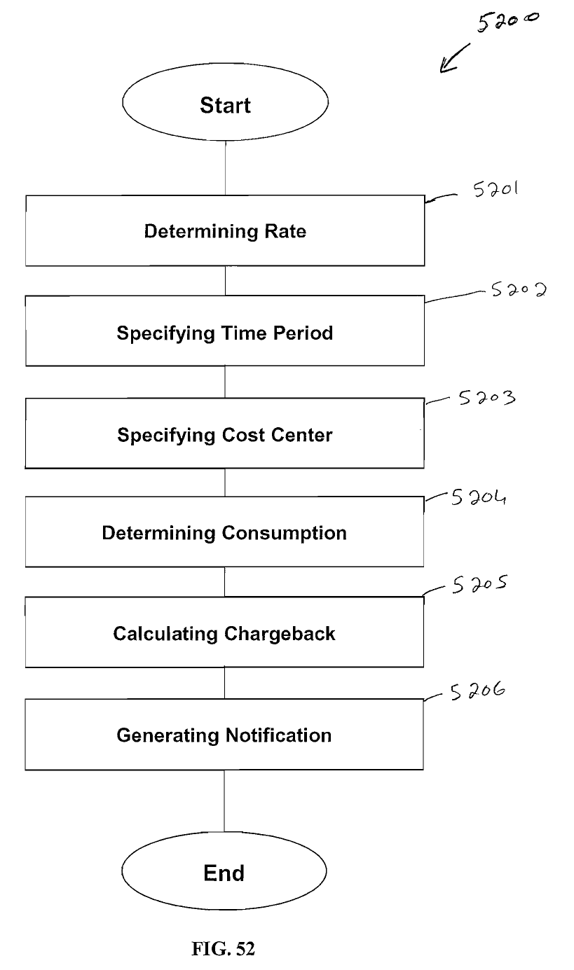

FIGS. 52-59 illustrate flowcharts showing the basic operations of chargeback in a virtual computing environment, according to exemplary embodiments of the present invention, and will be described hereafter.

Exemplary embodiments of the present invention provide for a method, system and apparatus for determining and presenting chargeback 108 and 203 of usage of virtualized computing resources 103. According to exemplary embodiments of the present invention, an entity or any user of the virtual computing environment can interact with the virtual computing environment via a browser (for example, intranet and/or internet) and/or any a user interface (for example, a graphical user interface).

According to an exemplary implementation, the present application provides a system that will allow entities (such as users) to set rates at all levels including but not limited to:
Virtual Machine
Host
Business Service (“BS”)
Customer
Global

According to exemplary embodiments, rates comprise unit costs for CPU, memory, storage, network and other virtual computing resources in predefined or custom increments. Entities (for example, a user or an organization) can define the rate as a unit cost for CPU, memory, storage and network in predefined and/or custom increments.

In an exemplary implementation, a programmatic process to set rates and user interface screens will be the same regardless at which system level the rates are set. When processing a chargeback report, the method, system and apparatus provide for checking if rates are set at the VM level, if no rate at the VM level, then Host level, if no rate at the Host level, then Business Service, if no rate at the Business Service level, then Customer, if no rate a the Customer level then Global. This process will allow for maximum flexibility to the user.

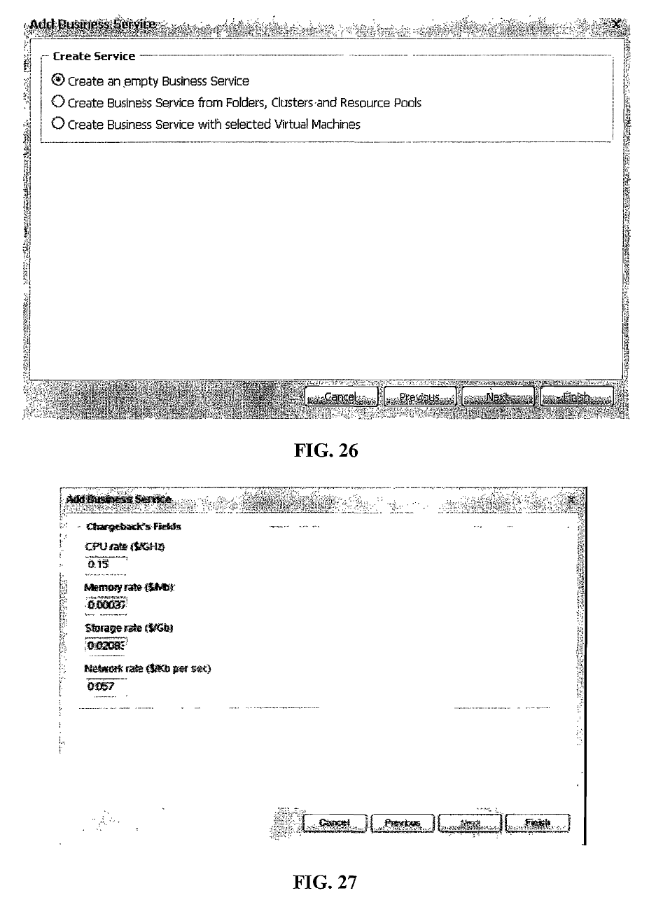

According to exemplary implementations, as shown in FIGS. 26-29, BSs relate to software and/or hardware computer application that support some kind of business function (for example, customer record management, email, and so on). According to exemplary embodiments, BSs are containers for capturing aggregate values among groups of virtual machines that either provide a single service, such as e-mail, or that differ in functionality but comprise a particular distributed application or business process, like CRM. Each entity (for example, a customer) can have multiple associate BSs. According to specific implementations BSs can also comprise ESX folders, cluster and resource pools. This provides BSs to be automatically updated when deploying additional machines. Embodiments of the present invention provide for constructing chargeback models for each virtual resource type or BS by taking a daily average of resources consumed then averaging those over the chargeback period (for example, a week or month). For example, an email system can be made up of several servers (one for filtering spam, another for processing emails, a third for relaying messages, and so on). For the purposes of chargeback, and according to exemplary implementations of the present invention, it would beneficial to view resources consumed by BSs as a whole. For example, a GUI implementing VMs for an “email system” can associate all VMs that support this email system BS with it, by dragging and dropping them on top of the business service. In addition, by viewing VMs and associated services as BSs, according to exemplary implementations of the present invention, it enables chargeback reporting for various levels of granularity for chargeback reporting and costs in relation to the entire BS. Specifically, according to implementations of the present invention, by determining unit costs and a given time period when creating a BS, the exemplary method, system and apparatus of the present invention enable generating a chargeback report for a given period of time based on all resources consumed. According to exemplary implementations shown in FIGS. 26-29, users can add BSs and define rates for enabling calculating chargeback amounts and costs. According to the exemplary implementation as shown in FIG. 26-29, for some and/or all virtual resources, an entity can specify a rate that will enable them to recover costs or make a desired profit according to the chargeback amount. Rates can be specified for any time period (for example, daily, monthly, yearly, and so on) for any virtual resource (for example, CPU, memory, storage, and network). These exemplary fields can also be used for generating a chargeback report. see FIG. 25-36.

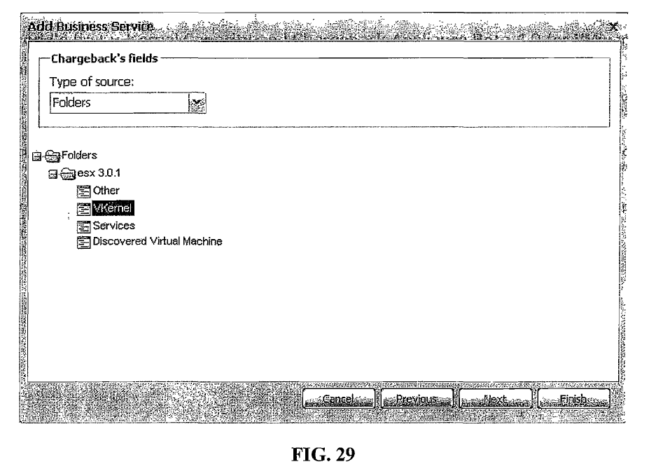

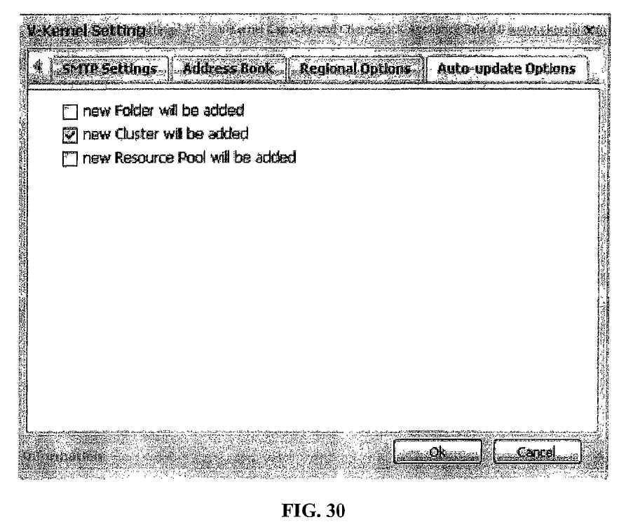

According to exemplary implementations BSs can be created from folders, clusters and resource pools, which can automatically synchronize with appropriate inventory objects (see FIGS. 29 and 30).

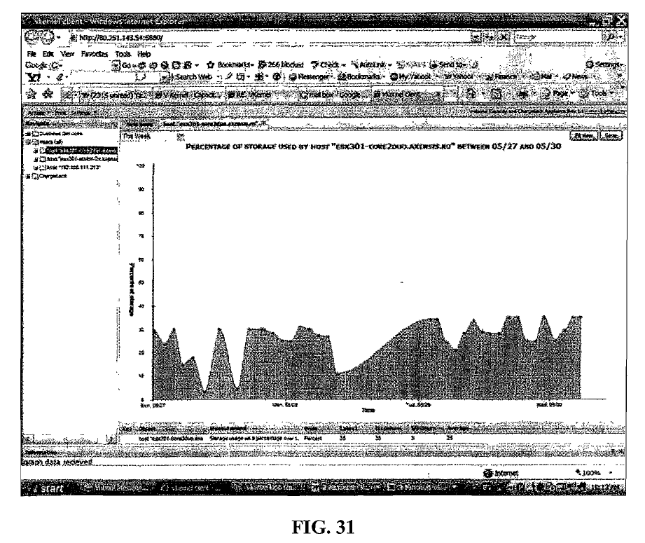

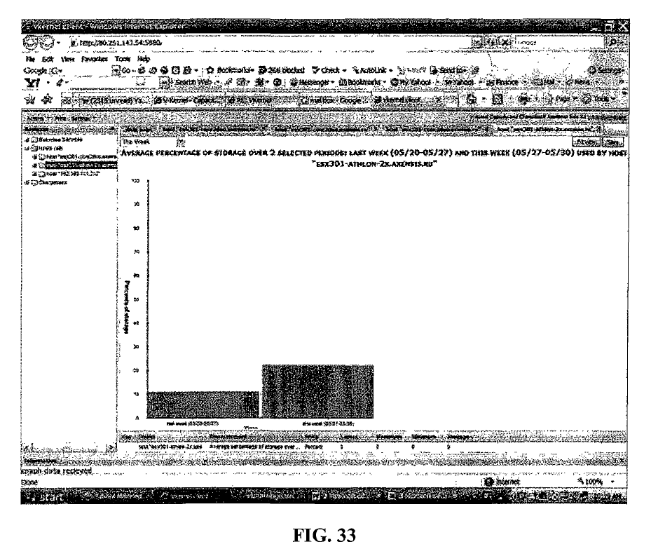

According to exemplary implementations, the method, system and apparatus of the present invention provide for generating resource consumption graphs (see FIGS. 31-33). Resource consumption graphs can show utilization, the actual amount of resources used, and resource change graphs (see FIG. 33) that compare utilization of resources between two points in time.

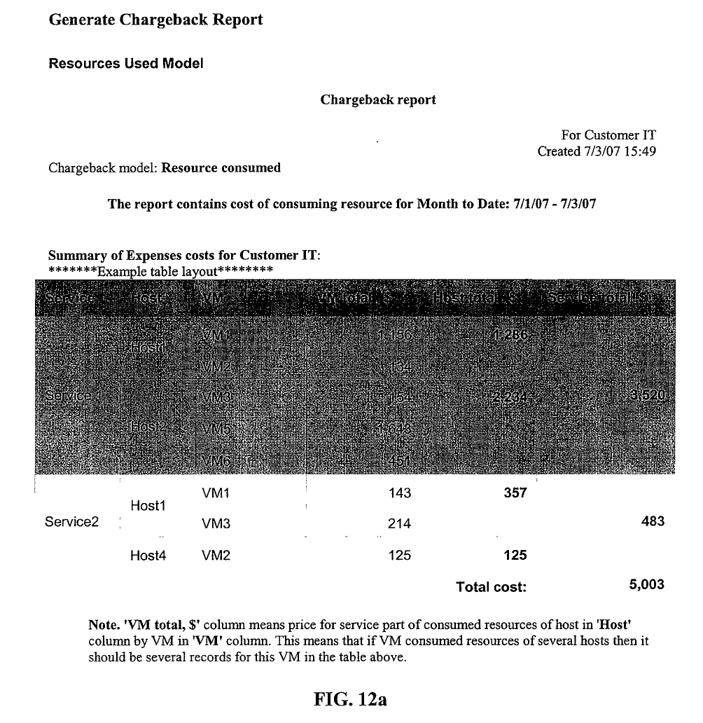

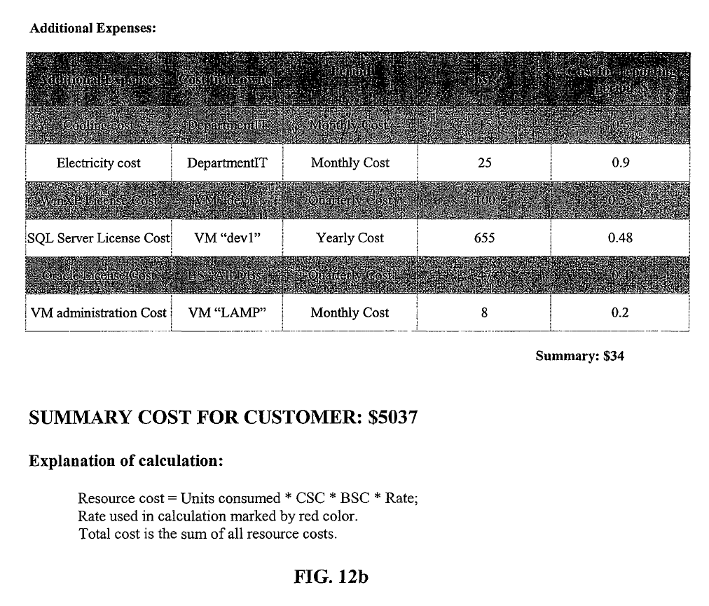

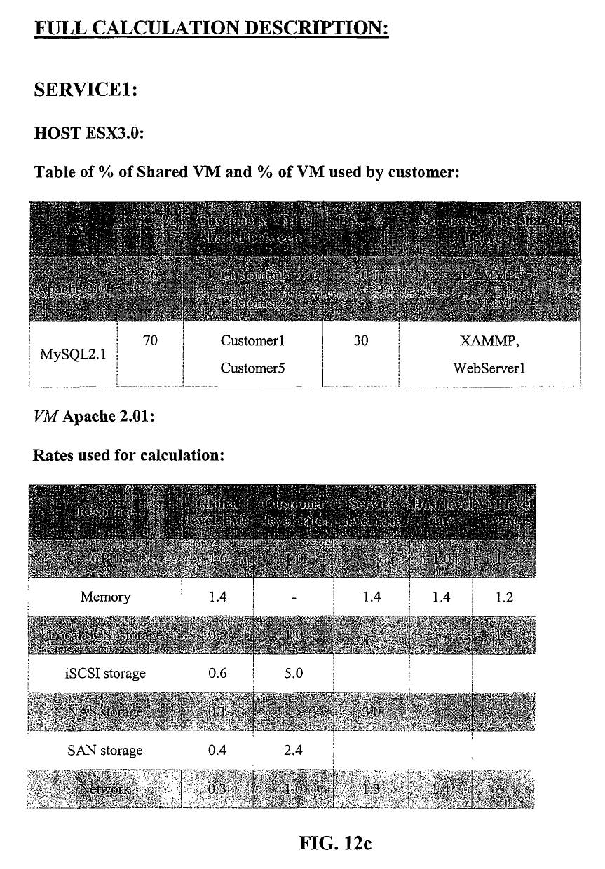

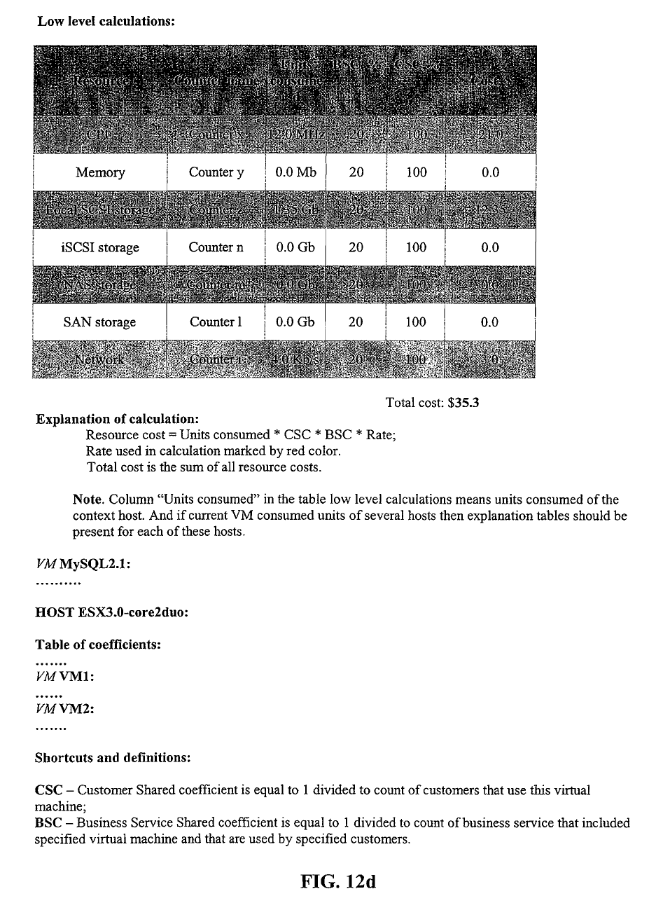

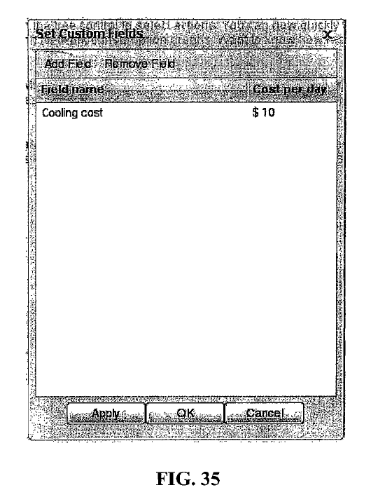

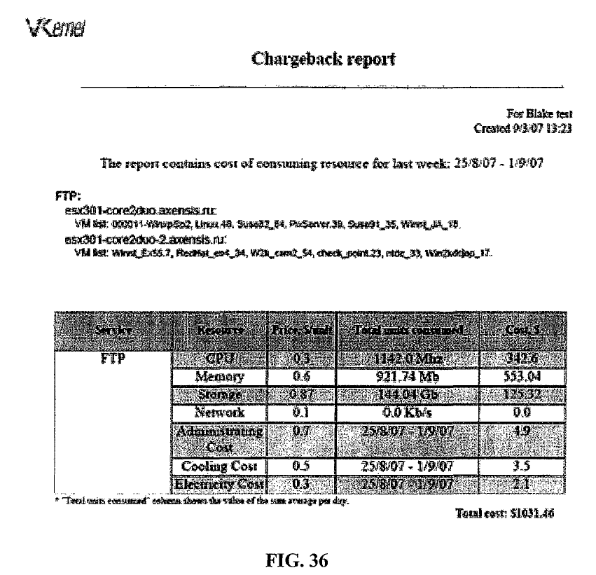

According to exemplary implementations, the method, system and apparatus of the present invention provide for generating chargeback reports (see FIGS. 12a-12d, 34 and 36). According to exemplary implementations, the fields in the chargeback reports can be customized (for example, added and/or removed) (see FIG. 35). If service already has custom fields, then the list containing these fields should be in an editable grid where can already existing field can be edited and/or removed. If a field does not already existing, then a new field can be added. Thereafter, a chargeback report for any BS will contain the newly defined and/or edited custom field (see FIG. 36).

In addition, exemplary embodiments of the present invention provide metered chargeback reporting and notification, in real-time or automatically at specified intervals, relating to capacity and resource consumption based on virtual computing resources including but not limited to CPU, RAM, storage and network. Additionally, an unlimited number of computing resources can be customized/specified by an entity for metering. For example, an entity may desire to meter and receive chargeback information for cooling costs, administrative services, software licensing.

According to exemplary embodiments, shown in FIGS. 46-50, chargeback reports can be scheduled for auto generation and email of chargeback reports. User's can receive scheduled reports vial e-mail by setting up SMTP settings.

Exemplary implementations will support an external RDMS for the enterprise edition. For example, a MS SQL 2000 or higher and Oracle x. Exemplary embodiments will support scripting.

Chargeback Models

As shown in FIGS. 4-11, exemplary embodiment of the present invention relate to calculating and/or presenting chargeback amounts and/or costs for one or more chargeback models. Certain implementations of the present invention provide users to customize the chargeback models (for example, database fields) and presentations (including presentation fields). Specifically, users and/or organizations can customize a chargeback model by customizing fields according to the desired virtual resources, rate level and chargeback model, in addition to zero or more default fields of a chargeback model. For example, default fields can include usage fields and/or over-usage fields, as described below.

In an exemplary implementation, every cost center node has its own customer record. Customer record holds information about rates and cost for BSs and VMs assigned to Customer and information about how much percents of cost for resource usage of each of BS or VM customer should pay.

According to an exemplary implementation, rates can be set at all levels, including but not limited to:
1. Virtual Machine
2. Host
3. Business Service
4. Customer
5. Global

According to an exemplary implementation, for each level, a chargeback model can be at least one of 3 types:
1. Resources Consumed
2. Fixed Price
3. Fixed Price+Over-usage

1. Resources Consumed Model

Exemplary embodiments of the resource consumed mode enable organizations to recover data center expenses by allocating costs to end user departments based on their actual use of hardware resources, software and other expenses in a datacenter. Computing departments must come up with rates for CPU, memory, storage and network that will recover the costs of buying new hardware, software and operating the datacenter, including profit for the organization.

Implementations of the resources consumed model provide for several advantages, including but not limited to:
1. Easy to understand
2. Quick to implement
3. Flexible—an organization can decide the timeframe for cost recovery.
4. Fair—end user departments get charged only for the resources they use.
5. Extensible—similar concepts can be applied to other implementations of chargeback for other expenses. For example but not limited to software licensing, administrative cost, electricity.

Usage Fields (Cost Per Unit/Day)

According to an exemplary implementation of the resources consumed model, usage fields allow users to set cost per unit/day including but not limited to:
1. CPU rate
2. Memory rate
3. Storage:
   a. NAS storage rate
   b. SAN storage rate
   c. SCSI local storage rate
   d. iSCSI storage rate
4. Network rate

Custom Fields (Fixed Cost Per Period)

According to an exemplary implementation of the resources consumed model, users have the option to add custom fields. Common examples of custom chargeback fields are costs for cooling, electricity and software license.

2. Fixed Price Model

Fixed Price Fields

According to an exemplary implementation, fixed price fields including but not limited to:

Fixed price field for stated amount of resource:
a. allocated amount of CPU per period
b. allocated amount of Memory per period
c. allocated amount of Storage per period
   allocated amount NAS storage
   allocated amount SAN storage
   allocated amount SCSI local storage
   allocated amount iSCSI storage
d. allocated amount of Network per period.

Custom Fields (Fixed Cost Per Period)

According to an exemplary implementation, users have the option to add custom fields. Common examples of custom chargeback fields are costs for cooling, electricity and software license.

According to an exemplary implementation, if the use is more than allocated, warning should be displayed on chargeback report (for example, to a user, administrator, and so on) comprising displaying how much resources were used (for example, over allowed limits and/or a threshold).

3. Fixed Price+Over-Usage Model

According to exemplary implementations, entities can efficiently and accurately utilize virtualized computing resources by metering resource usage (for example, by utilizing a hypervisor 204 for gathering performance metrics based on metering requests generated) that relates to the chargeback implementation 203 for charging back 203 for the use of extra resources beyond an allocated threshold, including fixed and over-usage cost of virtualized computing resources. For example, an entity can set threshold parameters for resource usage where embodiments of the present invention provide for calculating chargeback for fixed parameters and over-usage parameters. Fixed parameters relate to usage parameters while consumption is less than or equal to one or more of the threshold. Over-usage parameters relate to usage parameters when consumption goes over the threshold. According to exemplary implementations, over-usage parameters can vary from the fixed parameters. Exemplary implementations of the present invention determine that over-usage of the virtualized resources has occurred when usage of at least one of the virtualized resources exceeds one or more usage thresholds. Fixed and over-usage parameters can be implemented as fixed and over-usage fields, where fields can be customized depending on an exemplary implementation (for example, adding, removing and/or editing fields). The following example shows and implementation of fixed price, over-usage and custom fields:

Fixed Price Fields

According to an exemplary implementation, fixed price fields include but are not limited to:

Fixed price field for stated amount of resource:
a. allocated amount of CPU per period
b. allocated amount of Memory per period
c. allocated amount of Storage per period
   allocated amount NAS storage
   allocated amount SAN storage
   allocated amount SCSI local storage
   allocated amount iSCSI storage
d. allocated amount of Network per period.

Over-Usage Rate Fields

According to an exemplary implementation, over-usage rate fields include but are not limited to:
1. CPU rate
2. Memory rate
3. Storage
   a. NAS storage rate
   b. SAN storage rate
   c. SCSI local storage rate
   d. ISCSI storage rate
4. Network rate

Custom Fields

According to an exemplary implementation, users have the option to add custom fields for any model. Common examples of custom chargeback fields are costs for cooling, electricity and software license.

According to an exemplary implementation, fixed price and allocated amounts can be set at the same level.

Furthermore, according to the following exemplary implementation of the present invention, users and/or organizations can calculate daily chargeback rates for and IT resource including but not limited to CPU, memory, storage and/or network:

1. List all purchased hosts and the amount spend on hardware—list all server hardware used in the virtual environment including vendor name, model and/or any other naming convention used in the organization.

2. For each host, specify the time period in which the costs need to be fully recovered—organizations can experiment with different time frames to estimate and analyze the potential impact on rates.

3. For each host, specify how many departments, clients or cost centers will use the hardware and therefore be charged—this can relate to calculating and estimating how much the money will be needed to recover the cost for each host on a periodic (for example, daily, monthly, etc) basis for CPU and memory.

4. For each host, determine how many GHz of CPU is used on the host on average in a specific time period—figure out the total CPU cycles per month and determine the rate we need to charge when all or some of the CPU cycles are used. For an existing host, if the usage increases, this field will updated to ensure accurate calculation.

5. For each host, implementations of the present invention provide notification about the memory being consumed in a given time period—once it is known how much memory is being utilized for a specific host in a given month, implementations of the present invention can figure out how to relate it to the amount of money that is needed to recover per month to pay for the memory.

Chargeback Report Creation

In exemplary embodiments of the present invention, one or more chargeback reports can be created for one or more chargeback models of the present invention by the following non-limiting process:

Create Customer—Assign Business Services and VM's

User right mouse click on Chargeback node and choose “Add new customer”. “Add new customer” dialog should appear. User should set customer's name and description, assign VMs and BSs to the new created customer.

User should choose chargeback model on this step, because the next steps require this information.

After click on OK button customer node should be created under Customer Cost Center (CCC) node of the global tree. Rates for this type of chargeback should be taken from Global rates. If Global rates for this type of report are not set, an attempt to build report for this customer will be finished with alert.

In the exemplary tree above, business service nodes should contain “host” nodes for each host which was visited at least one time by the appliances of appropriative business service (without taking into consideration of history of business content). Hosts node allows rates to be set at “Host” level. Hosts nodes should list of all service appliance that were on this host at least one time in the past. Rates at VM level should be connected with appropriative hosts. So user has ability to set different rates for different hosts and the same business service.

Set Percentage Used Settings

According to an exemplary embodiment, an optional setting for the user, such as percentage used setting, can be provided as follows. If BS or VM is shared between some of the customers, or (and) BSs, than percentage of usage for this BSs and VMs will be set up in proportion (1/number of customers, VM or BS shared between). It is possible to set another proportion for percentage of usage using “Set percentage of usage” dialog. Dialog could be called from context menu of the VM node under customer's node of the global tree. There are 2 tabs for setting percentage of usage if the VM is shared between customers or (and) shared between all of BSs. Total sum for percentage of all customers should be 100%. If it is not, alert and/or alarm can appear.

A running total (%) should appear at the bottom of the dialog

Set Rates for CPU, Memory, Storage, Network

According to an exemplary embodiment, rates can be set at any level in the hierarchy utilizing any of the 3 chargeback models.

In an exemplary implementation, to set rates, a user can right click on virtual machine, host, business service, customer or the settings menu item and select Global Rates. In a more specific exemplary implementation, in order of precedence rates will be used in the following order:
Virtual Machine
Host
Business Service
Customer
Global.

According to exemplary embodiments of the present invention, reports can be generated and presented to any user for any one or more of the chargeback models.

1. Resources Consumed Model

In an exemplary implementation, to set rates, a user can right click on virtual machine, host, business service, customer or the settings menu item and select Global Rates, as illustrated in Fig _.

2. Fixed Price Model

In an exemplary implementation, to set rates right click on virtual machine, host, business service, customer or the settings menu item and select Global Rates, as illustrated in Fig _.

3. Fixed Price+Over-Usage Model

In an exemplary implementation, to set rates right click on virtual machine, host, business service, customer or the settings menu item and select Global Rates, as illustrated in Fig _.

Global Rates

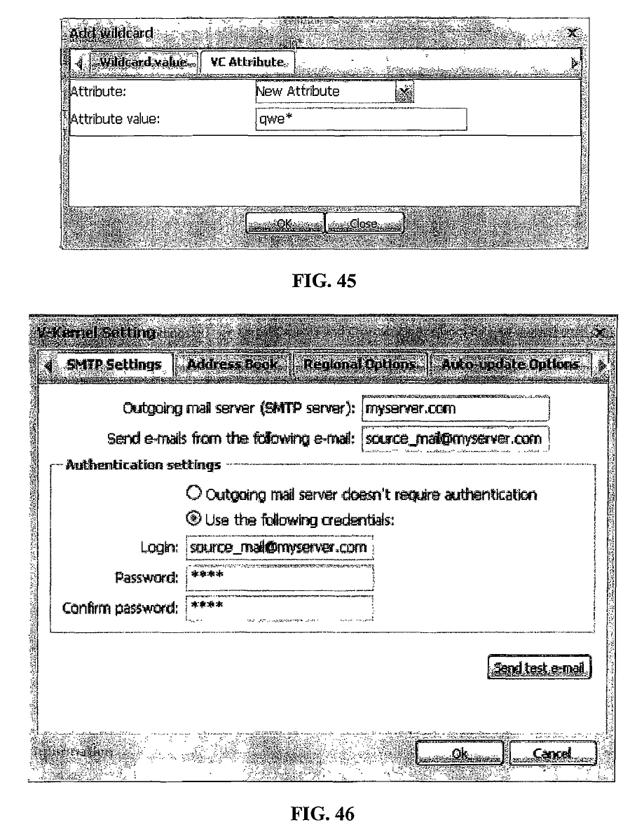

In an exemplary implementation, global rates can be set using the Global Settings dialog with active “Resource Used” global rates settings, as illustrated in FIG. 45.

Set Rates for Custom Chargeback Fields

In an exemplary implementation, a user has an option of setting customized chargeback fields, as illustrated in Fig _. For all chargeback models, the user interface for setting custom chargeback fields will be the same. Fig _, _ illustrates the Add Field and Remove buttons used to add and remove custom fields (for example, custom chargeback fields can include but are not limited to cooling, electricity and software license fees.) Specific implementations may not display these as default values and/or do not require user to set custom costs.

In an exemplary implementation, user can add and remove fields for customers or any of its service and/or VMs.

List of fields is editable, so it is possible to edit name and value of the filed right in the grid.

For example, as shown in Fig _ if user clicks on the “Add Field” button “Add Custom Field” dialog should appear. This dialog box can comprise at least four fields, “Field name”, “Field value”, “Field description” and “Rate Period”, which can be implemented as a radial button with 3 options, Monthly, Quarterly or Yearly. The radial buttons can default to monthly and upon generation of chargeback report, the appropriate calculation must be performed on the Custom Field value. Additionally, the column title in the chargeback report must include the correct name, “Monthly Cost”, “Quarterly Cost” or “Yearly Cost” respectively.

Generate Chargeback Report

In an exemplary implementation, chargeback report can be generated from the context menu of customer node. Reporting periods in drop down menu including, but not limited to:
1. Month to Date
2. Last Month
3. Quarter to Date
4. Year to Date
5. Free Form Date Range

Exemplary embodiments of the present invention provide a method for generating a notification comprising information indicative of at least one of chargeback amounts and chargeback costs to a user for usage (including fixed plus over-usage) of virtualized computing resources in a datacenter, wherein the method comprises generating a notification comprising information indicative of at least one of chargeback amounts and chargeback costs to a user for over-usage of virtualized computing resources. Notifications can be provided to at least one of an end user, a system administrator, a host server and a processor via an application programming interface (API). Furthermore, notifications can be provided via at least one of a graphical use interface, an application programming interface (API) and an electronic document. According to specific implementations, electronic documents comprise at least one of a browser, a image document, a spreadsheet and a word processing document. Notifications can be delivered via at least one of the Internet, an intra-net, paper documents, a Web-service API and any other means for delivering a notification.

Calculations

In an exemplary implementation, calculations can be generated for the consuming resources according to a user's specification. Calculations can be for generated for any one or more of the chargeback models.

Fixed Price Plus Over-Usage Model

According to exemplary embodiments, fixed cost plus overuse rates could be set for any level including but not limited to the levels described in the exemplary embodiments of the present application.

According to exemplary embodiments, each of the chargeback models can be customized and set for one or more levels. For example, in global settings it is possible to set fixed price plus over usage rate for customer level only. Fixed price plus over usage rates should be set for all objects on that level. For example if a VM level is chosen, than fixed price plus over usage rates should be set for all VM's under the all hosts node for this customer. In certain implementations, to use this type of reports is to use it with the customer level fixed price and rates, but if a user want to have a custom report (with rates on VM level for example), the user can set rates for all VMs.

FIG. 52 shows an exemplary embodiment of the present invention provides a method 5200 comprising determining one or more rate associated with determining chargeback for one or more virtual machine 5201, specifying a time period for calculating chargeback for each virtual machine 5202, specifying at least one cost center associated with each virtual machine 5203, determining consumption of virtualized computing resources for each virtual machine in the specified time period 5204, calculating chargeback for each cost center based for each virtual machine and generating a notification comprising said chargeback 5206, wherein each virtual machine is associated with virtualized computing resources.

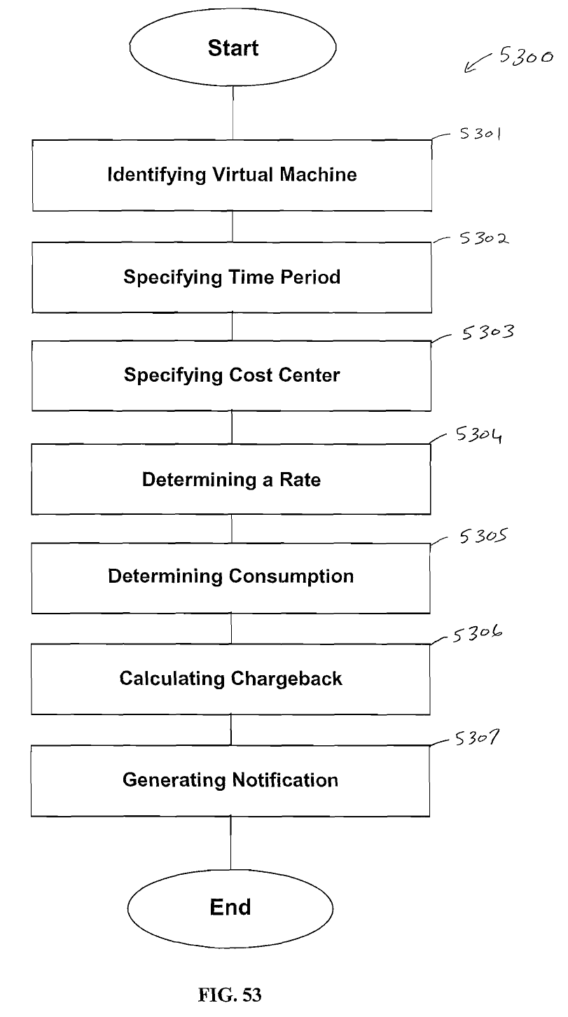

FIG. 53 shows an exemplary embodiment of the present invention provides a method for calculating and presenting chargeback costs for virtualized computing resources 5300 comprising identifying each virtual machine in the virtualized environment 5301, specifying a time period for calculating chargeback costs for each virtual machine 5302, specifying each cost center associated with each virtual machine 5303, determining rates for the virtualized computing resources associated with each virtual machine 5304, determining consumption of virtualized computing resources used by the cost center for each virtual machine within the time period 5305, calculating chargeback costs for each cost center 5306; and generating a notification 5307, wherein the chargeback costs reflect fixed plus over-usage of virtualized computing resources for each cost center and the rates, and wherein virtualized computing resources comprise one or more servers, a CPU, memory, storage and network.

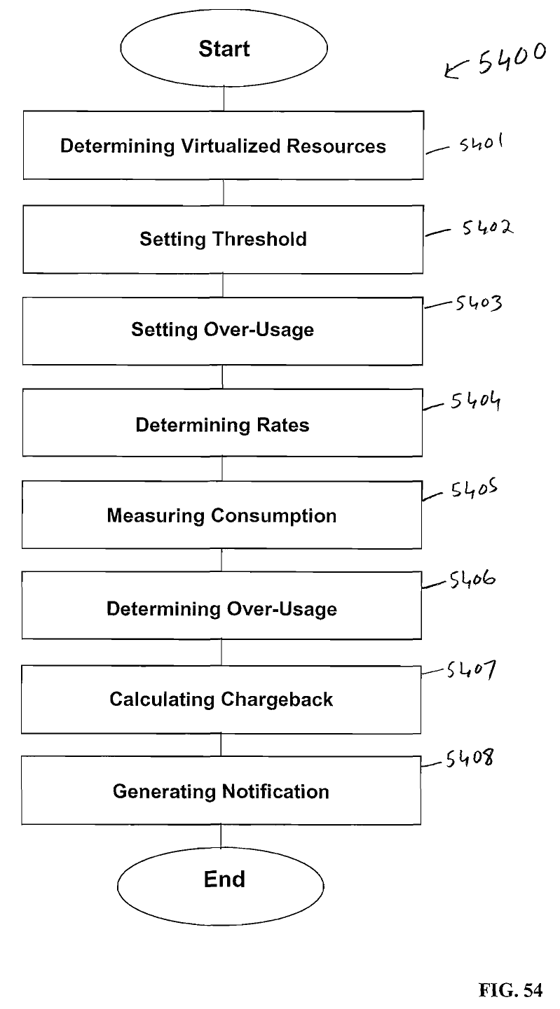

FIG. 54 shows an exemplary embodiment of the present invention provides a method for calculating and presenting chargeback of virtualized resources 5400 comprising determining virtualized resources related to one or more virtual machine 5401, setting one or more fixed usage threshold parameters for the virtualized resources 5402, setting one or more over-usage parameters for the virtualized resources 5403, determining rates for the usage of virtualized resources for each virtual machine, wherein the rates comprise a unit cost for fixed usage and over-usage of virtual resources 5404, measuring, for each virtual machine, consumption of the virtualized resources 5405, determining that over-usage of the virtualized resources has occurred when usage of at least one of the virtualized resources exceeds the fixed usage threshold parameters 5406, calculating chargeback amounts and chargeback costs comprising calculating fixed usage amounts and cost, and further calculating over-usage amounts and costs when over-usage is determined, based on said rates 5407, and generating a notification, comprising information indicative of at least one of chargeback amounts and chargeback costs 5409.

An exemplary embodiment of the present invention provides a method for setting fixed usage thresholds for users of virtualized computing resources, wherein the method comprises receiving at least one fixed usage threshold parameter for the virtualized resources, and storing the fixed usage threshold parameters.

An exemplary embodiment of the present invention provides a method for setting over-usage parameters for users of virtualized resources, wherein the method comprises receiving over-usage parameters for at least one of the virtualized resources, and storing the over-usage parameters.

An exemplary embodiment of the present invention provides a method for generating notification for consumption of virtualized computing resources, wherein the method comprises receiving usage data from the virtualized computing resources, determining consumption of the virtualized resources and generating a notification comprising information indicative of consumption of virtualized computing resources, wherein the notification comprises information indicative of at least one of chargeback amounts and chargeback costs.

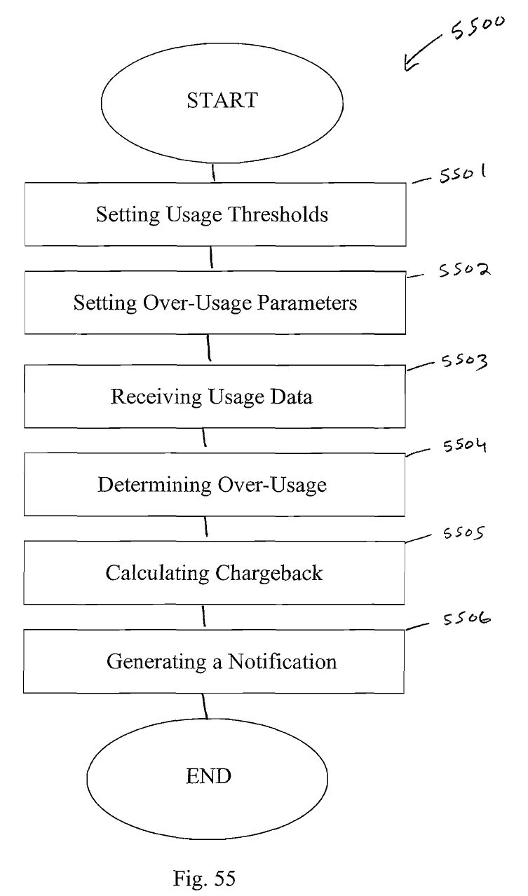

FIG. 55 shows an exemplary embodiment of the present invention provides a method for determining over-usage and generating a notification indicating chargeback related to over-usage, of virtualized computing resources 5500, wherein the method comprises setting one or more usage thresholds for the virtualized computing resources 5501, setting one or more over-usage parameters for the virtualized resources 5502, receiving usage data from the virtualized resources 5503, determining over-usage of the virtualized resources has occurred when usage of at least one of the virtualized resources exceeds one or more usage thresholds 5504, calculating at least one of chargeback amounts and chargeback costs comprising calculating usage amounts and cost, and further calculating over-usage amounts and costs when over-usage is determined, based on a rate 5505, and generating a notification, comprising information indicative of at least one of chargeback amounts and chargeback costs 5506, wherein rate comprises a unit cost for usage of virtualized computing resources including fixed usage and over-usage of virtual computing resources.

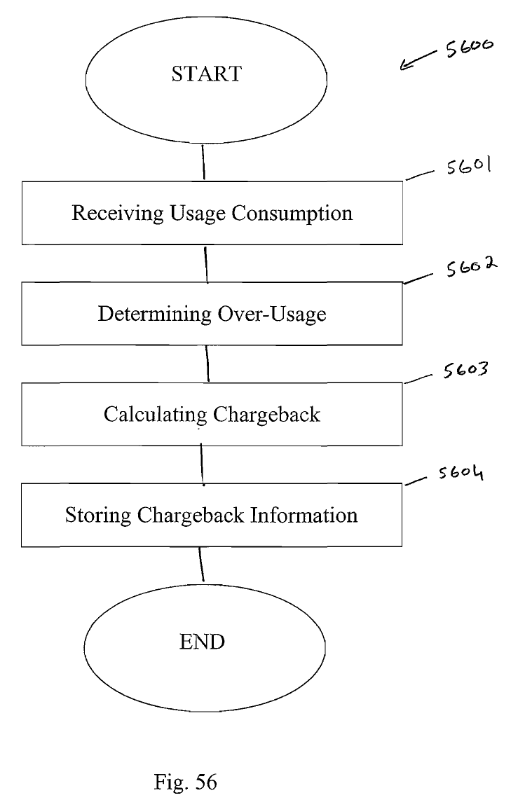

FIG. 56 shows an exemplary embodiment of the present invention provides a method for calculating and storing chargeback amounts and/or chargeback costs for virtualized computing resources when consumption of virtualized computing resources exceeds allocated usage thresholds 5600, wherein the method comprises receiving usage consumption data from the virtualized resources 5601, determining over-usage when one or more user of the virtualized computing resources has exceeded the fixed usage thresholds 5602, calculating chargeback amounts and chargeback costs when the consumption of the virtualized resources exceeds one or more fixed usage threshold 5603, and storing information indicative of one or more of chargeback amounts and chargeback costs to a user for over-usage of virtualized computing resources 5604, wherein chargeback amounts include quantified amounts of virtualized computing resources consumed for a virtual machine, and chargeback costs include monetary costs related to the consumption of virtualized computing resources for a virtual machine.

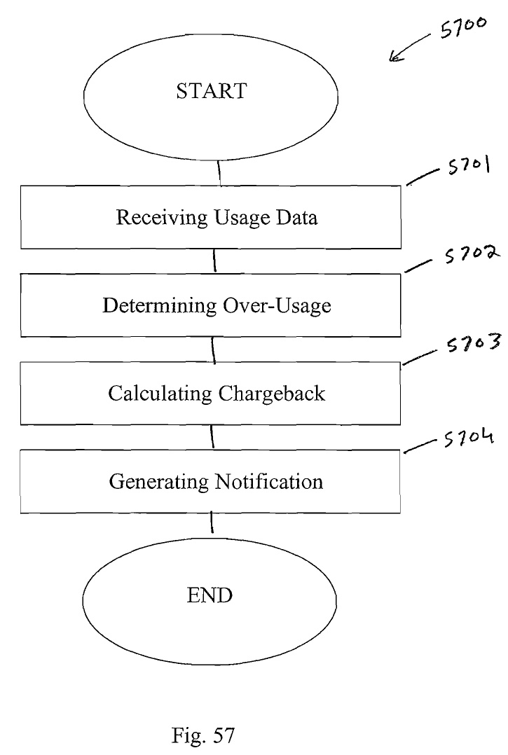

FIG. 57 shows an exemplary embodiment of the present invention provides a method for generating a notification comprising information indicative of at least one of chargeback amounts and chargeback costs to a user for over-usage of virtualized computing resources 5700, wherein the method comprises, receiving usage data from the virtualized computing resources 5701, determining over-usage of the virtualized resources has occurred when usage of at least one of the virtualized resources exceeds one or more usage thresholds 5702, calculating at least one of chargeback amounts and chargeback costs by calculating usage amounts and cost, and further calculating over-usage amounts and costs when over-usage is determined, based on a rate 5703, and generating a notification, comprising information indicative of at least one of chargeback amounts and chargeback costs 5704, wherein rate comprises a unit cost for over-usage of virtualized computing resources.

An exemplary embodiment of the present invention provides a method for creating and generating a chargeback notification, the method comprising determining chargeback amount and/or costs, and generating the notification.

An exemplary embodiment of the present invention provides a method for creating and/or maintaining a usage records for organizing chargeback of virtualized computing resources.

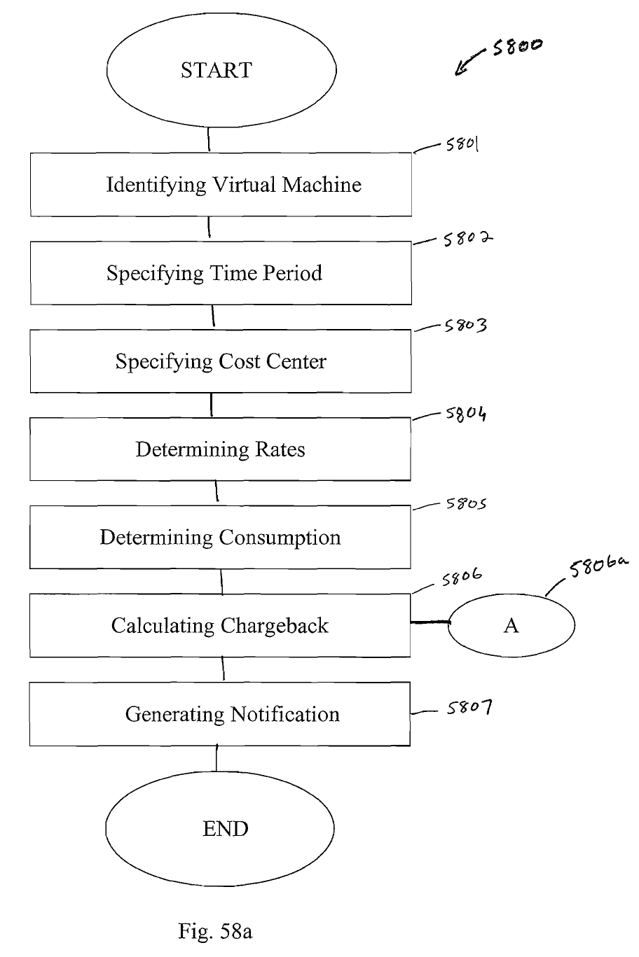

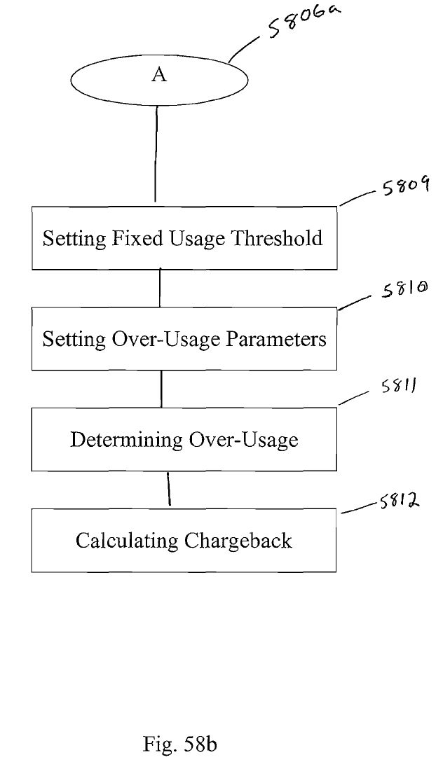

FIGS. 58a and 58b show an exemplary embodiment of the present invention provides a method for calculating and presenting chargeback of virtualized resources in a virtualized environment 5800 comprising identifying each virtual machine in the virtualized environment 5801, specifying a time period for calculating chargeback costs for each virtual machine 5802, specifying each cost center associated with each virtual machine 5803, determining rates for the virtualized computing resources associated with each virtual machine 5804, determining consumption of virtualized computing resources used by the cost center for each virtual machine within the time period 5805, calculating, for each virtual machine, chargeback costs for each cost center 5806, and generating a notification presenting chargeback costs 5807, wherein the chargeback costs reflect fixed plus over-usage of virtualized computing resources for each cost center and the rate, wherein virtualized computing resources comprise one or more servers, a CPU, memory, storage and network, and wherein calculating chargeback 5806a further comprises setting one or more fixed usage threshold parameters for the virtualized resources 5809; setting one or more over-usage parameters for the virtualized resources 5810, determining that over-usage of the virtualized resources has occurred when usage of at least one of the virtualized resources exceeds the fixed usage threshold parameters 5811, calculating chargeback amounts and chargeback costs comprising calculating fixed usage amounts and cost, and further calculating over-usage amounts and costs when over-usage is determined, based on said rates 5812.

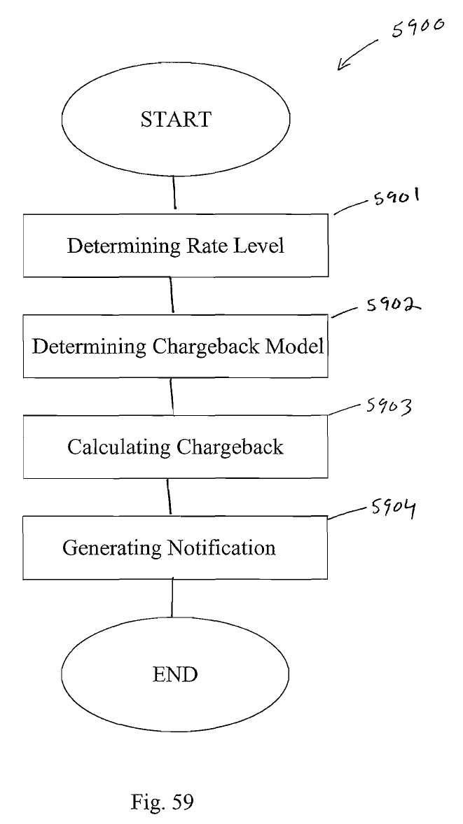

FIG. 59 shows an exemplary embodiment of the present invention provides a method for calculating and/or presenting chargeback for virtualized computing resources 5900, the method comprising determining selected rate level 5901, determining a chargeback model selected for the rate level 5902, calculating chargeback for the model 5903, and generating a notification presenting chargeback for the model 5904, wherein chargeback comprises chargeback amount and/or cost based on the chargeback model and rate level.

The above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, et and so on, including a carrier wave transmitting signals specifying the program instructions, data structures, et and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While the present invention has been shown and described with reference to certain exemplary embodiments thereof, it will be understood by those skilled in the art that various changes in form and details may be made therein without departing from the spirit and scope of the present invention as defined by the appended claims.

1. A method comprising:
identifying at least one rate associated with determining a chargeback for at least one virtual machine;
setting a time period for calculating the chargeback for the at least one virtual machine;
specifying at least one cost center associated with the at least one virtual machine;
determining a consumption of virtualized computing resources for the at least one virtual machine in the time period;
calculating the chargeback for the at least one cost center associated with the at least one virtual machine; and
generating a notification comprising information indicative of the chargeback,
wherein the at least one virtual machine is associated with at least one virtualized computing resource.

2. The method as claimed in 1, further comprising determining a chargeback model for the consumption, wherein the chargeback model comprises at least one of a resources consumed model, a fixed price model and a fixed price plus over-usage model.

3. The method as claimed in claim 1, wherein the chargeback comprises information indicative of an amount and/or cost associated with the consumption of the at least one virtualized computing resources.

4. The method as claimed in claim 3, wherein a cost associated with the at least one cost center is based at least on said rate and said consumption in the specified time period.

5. The method as claimed in claim 1, wherein the at least one virtualized computing resource comprises at least one of a CPU, memory, storage, network and customized parameters.

6. The method as claimed in claim 1, wherein the at least one rate comprises a unit cost for resources used, fixed usage and over-usage of virtual computing resources.

7. The method as claimed in claim 1, wherein the at least one cost center comprises at least one of a user, an entity, an organization and a department.

8.-11. (canceled)

12. An apparatus according to the method of claim 1, the apparatus comprising a computing system for executing instructions for the identifying setting, specifying, determining, calculating and generating.

13. A method for calculating and presenting chargeback costs for virtualized computing resources, the a method comprising:
identifying each virtual machine in a virtualized environment;
setting a time period for calculating chargeback costs for each virtual machine;
specifying at least one cost center associated with each virtual machine;
evaluating rates for virtualized computing resources associated with each virtual machine;
determining consumption of the virtualized computing resources used by the at least one cost center for each virtual machine within the time period;
calculating the chargeback costs for the at least one cost center; and
generating a notification,
wherein the chargeback costs is indicative of a fixed plus over-usage of virtualized the computing resources for the at least one cost center and the rates, and
wherein the virtualized computing resources comprise at least one of the server, a CPU, memory, storage and network.

14. A system for calculating and presenting chargeback costs for virtualized computing resources, according to the method of claim 13.

15. An apparatus according to the method of claim 13.

16. A method for calculating and presenting chargeback of virtualized resources, the method comprising:
identifying virtualized resources related to one or more virtual machine;
setting one or more fixed usage threshold parameters for the virtualized resources;
specifying one or more over-usage parameters for the virtualized resources;
computing rates for usage of the virtualized resources for each virtual machine, wherein the rates comprise a unit cost for fixed usage and over-usage of the virtual resources;
measuring, for each virtual machine, consumption of the virtualized resources;
determining whether an over-usage of the virtualized resources has occurred by comparing usage of at least one of the virtualized resources with the fixed usage threshold parameters;
calculating fixed usage amounts and cost;
calculating over-usage amounts and costs when the over-usage is determined;
calculating chargeback amounts and chargeback costs, based on the calculated fixed usage and over-usage amounts and costs said rates; and
generating a notification, comprising presenting information indicative of at least one of chargeback amounts and chargeback costs.

17. (canceled)

18. An apparatus for calculating and presenting chargeback of virtualized resources, according to the method of claim 16.

19. The method of claim 16,
wherein the setting the fixed usage threshold parameters comprises setting parameters indicative of at least one of fixed rates, fixed costs, fixed quantities, fixed resources and fixed amounts,
wherein the over-usage parameters comprise at least one of a overage rate, overage cost, overage quantities, overage resources and overage amounts.

20. The method of claim 16, further compromising providing the notification to at least one of an entity, an end user, a department of an organization, a system administrator, a host server and a processor via an application programming interface (API).

21.-32. (canceled)

33. A computer readable medium having stored thereon executable instructions for measuring and presenting the chargeback amount and/or cost of the virtualized computing resources, according to the method of claim 16.

34.-43. (canceled)

44. The method of claim 16, further compromising providing the notification via at least one of a graphical user interface, an electronic document and/or an audible notification.

45. The method of claim 44, wherein the electronic document comprises at least one of a browser, an image document, a spreadsheet and a word-processing document.

46. The method of claim 16, further compromising providing the notification via at least one of the Internet, an intra-net and an application programming interface (API).

47.-55. (canceled)

56. The method of claim 13, wherein generating the notification comprises presenting the chargeback costs.

57. (canceled)
